(19) United States
(12) Patent Application Publication
(10) Pub. No.: US 2010/0323657 A1
(43) Pub. Date: Dec. 23, 2010

(54) COMMUNICATION DEVICES

(76) Inventors: Russell Brett Barnard, Brighton East (AU); Anthony Darryn Reynolds, Marsfield (AU)

Correspondence Address: WINSTON & STRAWN LLP;PATENT DEPARTMENT, 1700 K STREET, N.W., WASHINGTON, DC, 20006, US

(21) Appl. No.: 12/670,044

(22) PCT Filed: Jul. 22, 2008
(86) PCT No.: PCT/AU08/01058

§ 371 Date: Sep. 13, 2010

Related U.S. Application Data
(60) Provisional application No. 60/964,117, filed on Aug. 10, 2007.

(30) Foreign Application Priority Data
Jul. 24, 2007 (AU) 2007903974

(51) Int. Cl. H04M 11/04; H04M 3/16; H04M 3/42; H04M 1/02

(52) U.S. Cl. 455/404.1; 455/410; 455/414.1; 455/557

(57) ABSTRACT

A method, system, and media directed to managing a mobile communications device. In one embodiment, a communication event and spatial state for the mobile device is received. If the event is at least one of a plurality of preselected types and the spatial state of the device satisfies a preselected condition, the communication event is call-processed while initiating a notification of the event to a user of the mobile device.

### TECHNICAL FIELD OF THE INVENTION

The application relates to managing a mobile device, including to managing the operations of the mobile device based on spatial states of the mobile device.

### BACKGROUND OF THE INVENTION

The features associated with current communication devices and units, such as personal digital assistants, mobile telephones, fixed telephones (such as Fixed In-Vehicle telephones) are in general directed to enhancing the use of the unit by the user. Thus, for example, it is common for such devices to comprise cameras, games, picture viewers, video and sound players (such as MP3 players), calendars, task lists, email applications etc. Furthermore, current communication devices are designed for the personal-use market, rather than with industrial applications in mind.

Despite the long period of time over which such devices have been available, such units lack certain practical features, such as, for example, significant safety and/or location features, designed to provide greater safety and/or greater information about the location of a user.

Portable and Fixed In-Vehicle cellular mobile telephones “CMT” have been around for over two decades. There is however a growing need to improve the safety aspect of when these devices can and should be permitted to be used. In some industries, there is an increasing need to limit the operational parameters of when the device can be used in part or full. For example, it is not uncommon for the operators of petrochemical transport fleets to attempt to limit the use of mobile telephones to that of when the vehicle, in this case a large petrol tanker, is stationary by using a costly and time consuming installation of a relay switch connecting the phone to the air brake electronics of the truck. Once the air brakes are engaged a relay switch is then triggered to allow power to the phone. The device could be either a Fixed In-Vehicle phone or a portable phone that is mounted in an installed hardwired car kit. A problem with the latter is the portable will have an internal battery enabling the driver to switch on the phone regardless of the wiring of the relay set up in the vehicle. In many cases this industry relies on the driver of the vehicle to “do the right thing” and use the phone when permitted by operational policy.

Other issues and problems arise when using the air brake method to disable the CMT whilst in motion. There are some circumstances in regards to the operation of a petrol tanker in this example that actually require the phone to be not accessed when stationary. For example it is not uncommon for fleet operators of petrochemical trucks to instruct to NOT permit the use of the mobile device when:

1) Refueling the tanker at a refinery.

2) When emptying the fuel load at the petrol stations.

There are other environments where the use of the CMT whilst in motion is not desirable. Two examples here would be, firstly not allowing use of the CMT in school zones which in many countries have lower speed limits to the prevailing streets. A second example would be not to permit use of the CMT in roadway tunnels as a further step to reducing the potential of an accident due to any lack of concentration on the driver's behalf in such a confined space with limited or no means for other vehicles to evade an accident ahead.

Limiting the use of the CMT, in this petrol tanker example, using the relay to the air brakes method has additional downsides. Whilst disabling the phone via the connections to the air brake system is successful in preventing all use of the CMT, it itself creates non desirable limitations for the use of this phone. A reason for effectively shutting down the phone is to prevent normal inbound and outbound calls to the petrol tanker whilst in motion, it also means that in the event that the driver may be required to make an emergency call (000, 911 etc) he is unable to do so until the truck is both stopped and the air brakes on. In addition to the time taken for the vehicle to come to a complete stop, assuming even this was safe to do so; the driver would also then have to wait the critical seconds for the phone to power up and then register onto the cellular network before being able to call for emergency assistance. An improved method of controlling the functioning of a communications device is thus needed.

### SUMMARY OF THE INVENTION

One embodiment of the present invention is directed to a method for managing a mobile device. In one embodiment, the method includes receiving information for determining a spatial state of the mobile device; receiving a communication event for the mobile device. If the communication event is at least one of a plurality of preselected types and the spatial state of the device satisfies a preselected condition, call-processing the communication event while initiating a notification of the event to a user of the mobile device. Otherwise, disabling at least the call-processing of the communication event or the notification of the event to the user.

Such call-processing can comprise, for example, processing a Short Message Service (SMS) message, processing an alarm, forwarding the communication event, or recording a missed call within a memory which for example may be in the mobile device. In some embodiments, the spatial state might for example comprise a speed of the mobile device, an acceleration of the mobile device, a position of the mobile device, an altitude of the mobile device, a vibration of the mobile device, or a combination thereof. In yet another embodiment, the condition is detected if the device is determined to be within an on-ground stage, wherein the on-ground stage is based on an altitude in proximity to a ground level or a vibration associated with a landing. Another aspect of the invention is directed to a processor readable medium comprising instructions for performing the method.

Yet another aspect of the invention is directed to a system for managing a mobile device. The system includes a transceiver for communicating data over a network; a spatial sensor; and a processor. The processor may be configured to perform actions comprising: receiving a communication event from the transceiver, determining a spatial state of the device based on information from the spatial sensor, determining if the event is at least one of a preselected plurality of types and a spatial state of the device satisfies at least one preselected condition, and based on a result of the determining step, call-processing the communication event while disabling an indication of the event to a user of the mobile device. In some embodiments, the spatial sensor comprises one or more of: an altimeter, a barometer, an accelerometer, a pressure sensor, a thermometer, a Global Positioning System (GPS) component, a Radio Triangulator, an inertial sensor, a speedometer, an odometer, or a vibration sensor. In yet another embodiment, the system may comprise an internal battery backup configured to provide power to the mobile device if an external power supply fails, wherein the mobile device is fixed to a mount and powered by the external power supply, wherein the actions further comprise communicating a failure of the power supply over the network.

Another aspect of the invention is directed to a method, system and processor readable media for managing a mobile device and a processor readable medium for perform the method. The method comprising configuring a mobile device to save data (such as a statistic) based on at least one change of a spatial state of the mobile device associated with a use of the device outside working parameters for the device; and providing an indication that the device is out of warranty based on the data.

Another aspect of the invention is directed to a system and method for interchanging a mobile device and a system for using the method. The method includes interchanging the mobile device from a portable to fixed mobile device or a mobile to fixed device by replacing a first rear cover a second rear cover such as a fixed back plate, and/or coupling or decoupling a power and communication connection.

In one embodiment of the invention there is provided a communications device comprising a motion sensor to measure changes in forces applied to the device. In another embodiment of the invention there is provided a communications device comprising a motion sensor to assist with tracking and location of the device. In one embodiment of the present invention, there is provided a communications device comprising a sensor to receive data relevant to the relative height of the device as compared to another device or point in space and a data storage mechanisms to store the data.

In one embodiment of the present invention, there is provided a hand-held communications device comprising an electromagnetic shield to restrict transmission of electromagnetic radiation towards a body part of the user. A shield according to this embodiment of the invention may comprise any suitable form, for example, it may comprise electromagnetic field reflecting, inhibiting and/or absorbing material. The shield may protect any suitable body part, and in some preferred embodiments, it is the head.

In one embodiment of the present invention, there is provided a fixed-In-Vehicle communications device comprising a back-up source mechanism to provide power in the event of loss of power from the vehicle.

According to one embodiment of the present invention, there is provided a fixed-In-Vehicle communications device comprising an internal antenna. A unit according to this embodiment of the invention may still operate on a cellular phone network even in the event that the externally mounted cellular antenna is unable to be used, for example, if it is removed, stolen, faulty, or damaged.

According to one embodiment of the present invention, there is provided a fixed-In-Vehicle communications device comprising software and/or hardware to monitor the vehicle's electrical systems, such as the vehicle battery condition. In one embodiment of the invention, there is provided a communications device comprising text-to-speech functionality in which text displayed in the screen of a unit, such as a mobile phone is converted to speech. In one embodiment of the invention, there is provided a communications device comprising an interchangeable portion so as to enable the same basic unit to become a fixed-In-Vehicle or a handheld unit.

In one embodiment of the present invention, there is provided a communications device comprising a floatation component. The floatation component may form any suitable part of the unit, and in some embodiments it comprises the cover and may, for example, comprise a compartment within or defined by the cover.

According to one embodiment of the invention, there is provided a communications device comprising an SMS disabling function. In one embodiment of the invention, there is provided a communications device comprising multiple SIM card capability, and wherein different call types or phone numbers may be tagged to a particular SIM card without the need to manually select which SIM the user wishes to use.

In one embodiment of the invention, there is provided a communications device comprising voice recognition software that allows some or all of the unit's features to be used by one or more authorised users depending on the user's voice signature or imprint.

According to one embodiment of the invention, there is provided a communications device comprising a battery which is able to be charged inductively. In one embodiment of the present invention, there is provided a communications device comprising a visual display function, such as a flash sequence function responsive to a device function or event.

In one embodiment of the invention, there is provided an accessory for use with a communications device wherein the accessory enables a duress or emergency signal to be sent from the device. In one embodiment of the invention, there is provided a communications device comprising software that allows the use of one or more existing buttons on a commonly available wireless accessory to a mobile phone, to be used to trigger an emergency duress alert phone call, SMS message or both.

In one embodiment of the invention, there is provided a communication device comprising a receiver, a transmitter and a processor and further comprising a safety feature to increase the safety of the user. In some preferred embodiments, the safety feature comprises a location feature, such as a motion sensor, altimeter, accelerometer, gyroscope, GPS, etc.

One embodiment comprises a method for managing a mobile device, comprising: receiving information for determining a spatial state of the mobile device; receiving a communication event for the mobile device; if the communication event is at least one of a plurality of preselected types and the spatial state of the device satisfies a preselected condition, call-processing the communication event while initiating a notification of the event to a user of the mobile device; and, otherwise, disabling at least the call-processing of the communication event and/or the notification of the event to the user.

In some embodiments, if the communication event is not one of the preselected types or the spatial state does not satisfy the preselected condition, the communication event is call-processed and the notification of the event to the user is disabled. The call-processing may for example comprise one or more of: enabling audio and/or visual communication by the user, storing a Short Message Service (SMS) message, activating an alarm, forwarding the communication event to another device, or, recording a missed call within a memory.

The spatial state may for example comprise one or more of: a speed and/or velocity of the mobile device, an acceleration of the mobile device, a position of the mobile device, an altitude of the mobile device, a vibration of the mobile device, or, a combination thereof.

In another embodiment, there is provided a system for managing a mobile device, comprising: a transceiver for communicating data over a network; a spatial sensor; and, a processor configured to perform actions comprising: receiving a communication event from the transceiver; determining a spatial state of the device based on information from the spatial sensor, determining if the event is at least one of a preselected plurality of types and a spatial state of the device satisfies at least one preselected condition, and, based on a result of the determining step, call-processing the communication event while disabling an indication of the event to a user of the mobile device.

The spatial sensor may for example comprise an altimeter, a barometer, an accelerometer, a pressure sensor, a thermometer, a Global Positioning System (GPS) component, a Radio Triangulator, an inertial sensor, a speedometer, an odometer, or a vibration sensor.

In another embodiment, there is a processor readable medium for managing a mobile device comprising instructions that when executed by a processor causes the processor to perform actions comprising: receiving a communication event for the mobile device; if the event satisfies and a determined spatial state of the device satisfy one or more preselected conditions for disabling at least a portion of the device, performing a call-processing configured for the device while disabling another call-processing configured for the device; and, otherwise, performing the call-processing while performing the other call-processing.

In one embodiment, there is provided a method for managing a mobile device, comprising: configuring a mobile device to save data based on at least one change of a spatial state of the mobile device associated with a use of the device outside working parameters for the device; and, optionally providing an indication that the device is out of warranty based on the data.

In another embodiment, there is a system for managing a mobile device, comprising: a mobile device configured to save data in relation to at least one change of a spatial state of the mobile device associated with a use of the device outside working parameters for the device; and, a warranty component configured to receive the data; and optionally provide an indication that the device is out of warranty based on the statistic.

One embodiment provides a processor readable medium for managing a mobile device comprising instructions that when executed by a processor causes the processor to perform actions comprising: configuring a mobile device to save a statistic of at least one change of a spatial state of the mobile device associated with a use of the device outside working parameters for the device; and, optionally providing an indication that the device is out of warranty based on the statistic.

In another embodiment, there is provided a system for interchanging a mobile device, comprising: a rear cover interchangeably attached to a rear side of the mobile device; a power connection in communication with the mobile device; a communication connection in communication with the mobile device; and, a fixed back plate attached to a mounting configured to attach to the rear side of the mobile device to interchange the rear cover after removal of the rear cover from the rear side of the mobile device, wherein the fixed back plate includes another connection configured to be coupled to the power and communication connections.

Some embodiments provide a communications device comprising software that allows the use of one or more existing buttons on a commonly available wireless accessory to a mobile phone, to be used to trigger an emergency duress alert phone call, SMS message or both.

In one embodiment, there is a communications device comprising one or more of: a motion sensor to measure changes in forces applied to the device and/or to assist with tracking and location of the device; a sensor to receive data relevant to the relative height of the device as compared to another device or point in space and a data storage means to store the data; an electromagnetic shield to restrict transmission of electromagnetic radiation towards a body part of the user; a back-up source to provide power in the event of loss of power from the vehicle; an internal antenna; software and/or hardware to monitor the vehicle's electrical systems, such as the vehicle battery condition; text-to-speech functionality; an interchangeable portion so as to enable the same basic unit to become a fixed-in-vehicle or a handheld unit; a floatation component; multiple SIM card capability, and wherein different call types or phone numbers may be tagged to a particular SIM card without the need to manually select which SIM the user wishes to use; voice recognition software that allows some or all of the unit's features to be used by one or more authorised users depending on the user's voice signature or imprint; a battery which is able to be charged inductively; a visual display function, such as a flash sequence function responsive to a device function or event; enabled to interoperate with an accessory wherein the accessory enables a duress or emergency signal to be sent from the device; software that allows the use of one or more existing buttons on a commonly available wireless accessory to a mobile phone, to be used to trigger an emergency duress alert phone call, SMS message or both; a receiver, a transmitter and a processor and further comprising a safety feature to increase the safety of the user wherein the safety feature is enabled by one or more of a motion sensor, altimeter, accelerometer, gyroscope, and GPS; a transceiver for communicating data over a network; a spatial sensor which comprises an altimeter, a barometer, an accelerometer, a pressure sensor, a thermometer, a Global Positioning System (GPS) component, a Radio Triangulator, an inertial sensor, a speedometer, an odometer, or a vibration sensor; a processor configured to perform actions comprising: receiving a communication event from the transceiver; determining a spatial state of the device based on information from the spatial sensor; determining if the event is at least one of a preselected plurality of types and a spatial state of the device satisfies at least one preselected condition, and, based on a result of the determining step, call-processing the communication event while disabling an indication of the event to a user of the mobile device; configuration to save data in relation to at least one change of a spatial state of the mobile device associated with a use of the device outside working parameters for the device; a warranty component configured to receive the data; and provide an indication that the device is out of warranty based on the data; a rear cover interchangeably attached to a rear side of the mobile device; a power and communication connection in communication with the mobile device; and, a fixed back plate attached to a mounting configured to attach to the rear side of the mobile device to interchange the rear cover after removal of the rear cover from the rear side of the mobile device, wherein the fixed back plate includes another connection configured to be coupled to the power and communication connection.

In some embodiments, there is provided a communication device comprising a receiver, a transmitter and a processor and further comprising a safety feature to increase the safety of the user wherein the safety feature is enabled by one or more of a motion sensor, altimeter, accelerometer, gyroscope, and GPS.

One embodiment provides a method for managing a mobile device, comprising: receiving information for determining a spatial state of the mobile device; disabling the mobile device if the spatial state satisfies a preselected condition, and, optionally re-activating the mobile device once a second preselected spatial state condition is met.

A related embodiment provides a system for managing a mobile device, comprising: a transceiver for communicating data over a network; a spatial sensor; and, a processor configured to perform actions comprising: determining a spatial state of the device based on information from the spatial sensor; determining if the spatial state of the satisfies at least one preselected condition, and, based on a result of the determining step, disabling the mobile device and/or disabling an indication of the event to a user of the mobile device.

Some embodiments of the invention comprise combinations of one or more, or in some cases, all of the various features described herein.

### BRIEF DESCRIPTION OF THE DRAWINGS

FIG. 1 is a schematic showing the components of a cellular mobile telephone according to one embodiment of the invention;

FIG. 2 provides an example of a trigger event process as handled by software according to the present invention;

FIG. 3 is a schematic showing various configurations for voltage supply;

FIG. 4 is a schematic demonstrating auto in-flight mode;

FIG. 5 is a schematic showing interaction of the accelerometer with auto flight mode;

FIG. 6 depicts a prior art Fixed In-Vehicle phone;

FIG. 7 depicts a prior art portable mobile phone;

FIG. 8 depicts some of the steps taken to convert a portable version of a phone according to the present invention to a fixed in car version;

FIG. 9 is a rear view of a phone according to the present invention from which the back cover has been removed;

FIG. 10 depicts further steps taken to convert a portable version of a phone according to the present invention to a fixed in car version; and,

FIG. 11 depicts a portable mobile phone according to the present invention together with its car kit.

### DETAILED DESCRIPTION OF EXEMPLARY EMBODIMENTS

It is convenient to describe the invention herein in relation to particularly preferred embodiments. However, the invention is applicable to a wide range of situations and it is to be appreciated that other constructions and arrangements are also considered as falling within the scope of the invention. Various modifications, alterations, variations and/or additions to the construction and arrangements described herein are also considered as falling within the ambit and scope of the present invention.

Throughout this specification (including any claims which follow), unless the context requires otherwise:
(a) the word “comprise”, and variations such as “comprises” and “comprising”, will be understood to imply the inclusion of a stated integer or step or group of integers or steps but not the exclusion of any other integer or step or group of integers or steps;
(b) the word “software” means (i) software (processor readable media comprising processor executable instructions), or (ii) firmware, or (iii) any equivalent mechanism or system that enables a computer system to perform specific tasks, or any combination thereof;
(c) the terms “unit” or device” or “communication unit” or “communication device” are used to mean any communication device including by way of example only: fixed, portable, mobile, handheld, and/or In-Vehicle communication devices, such as personal digital assistants, pocket computers, handheld computers, blackberry devices, pagers, telephones, radio cellular telephones, etc.;
(d) the terms “mobile device” is used to mean any mobile device configured to communicate at least voice data, including by way of example only: a phone, mobile phone, cell phone, any of the devices described in (c) above, or the like;
(e) the term “communication event” refers to any incoming or outgoing communication to or from a device;
(f) the term “spatial state” refers to information representative of a point in space or a function based on the point in space, such as a change in the point, a frequency of change or acceleration, or the like;
(g) the term “spatial sensor” refers to a component for measuring at least one spatial state. A spatial sensor can measure for example, position, speed, acceleration, vibration, etc.

In one embodiment, the invention allows for the complete disabling of inbound and outbound calls whilst allowing the phone itself to be switched on and logged on to the cellular network and at the same time also permit the dialing of emergency numbers and/or a predetermined and stored list of approved numbers from the fleet operator if so desired. In another embodiment, our invention allows for a variety of speed or other spatial dependent conditions that cause the disabling of inbound and outbound calls. As used herein, the term “condition” refers to any preselected configurations or settings. SMS messages etc. from the CMT. Our invention also allows for the creation of geographical zones where the CMT is not permitted to be used with or without speed dependent conditions in place.

There are some instances where use of a mobile phone is not permitted at all, including the dialing of emergency numbers. In these environments the transceiver section of the phone may be shut down completely. For example the use of phone during flight is prohibited in most jurisdictions. Using the motion of the plane itself to effectively create an Auto Flight Mode to shut down the transceiver automatically provides a guarantee that this prohibition is followed without the requirement of user intervention, as well as preventing the user from defying the prohibition.

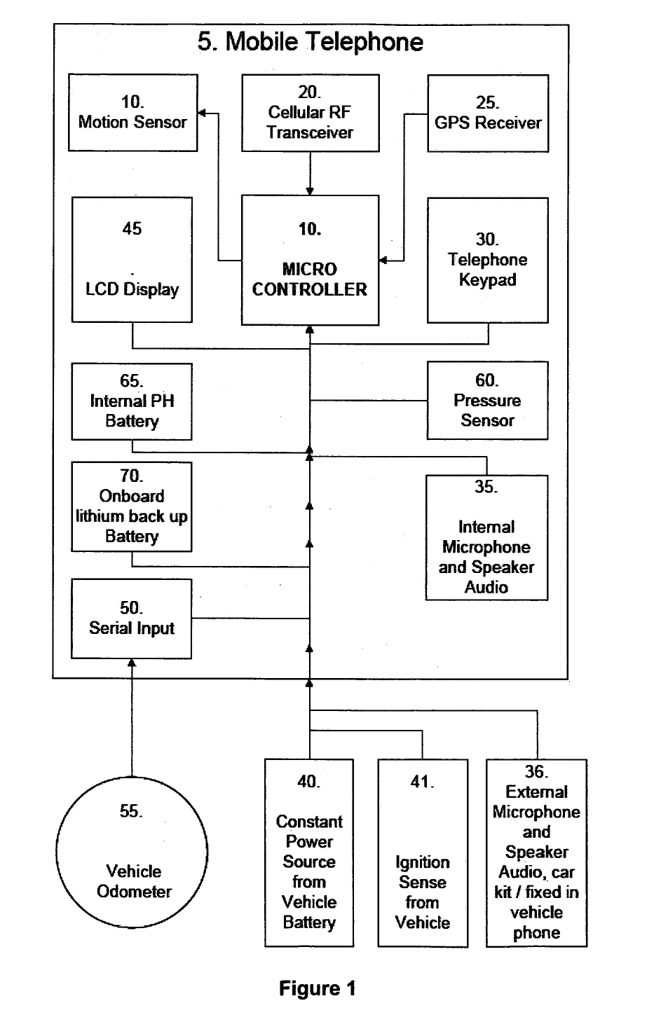

FIG. 1 details some of the major components or sections found within a Cellular Mobile Telephone “CMT”. In addition to the components found in most cellular telephones, certain embodiments of the invention also incorporate a pressure sensor (60), and/or a motion sensor (10) and this would typically be an accelerometer. In this example, the CMT also comprises an on-board GPS receiver (25). Use of an external GPS device with a compatible communications link to the CMT, i.e. a Bluetooth equipped external GPS device, could also be utilized in replacement of the on-board GPS. The CMT also has a serial data interface (50) to allow connection to a vehicle odometer or any other external speed sensing device so that speed information may be sent to the CMT. Also shown is vehicle odometer (55) in communication with serial input (50). Constant power source from vehicle battery (40) also provides power to the CMT. Ignition sense from Vehicle (41) and external microphone and speaker audio for a car kit/Fixed In-Vehicle phone (36) is in communication with the components of CMT.

Configuration of the CMT detailed in FIG. 1 applies to both Fixed In-Vehicle versions and standard portable versions. For the use of serial input (50) into a portable CMT the unit is first be placed into its dedicated cradle that forms part of the handsfree car kit, which, in this application, may be a “Hard-wired Installation”. Application and use of the Accelerometer and/or GPS receiver is applicable to Fixed In-Vehicle and Portable Phones, the later with or without the use of a hardwired installed handsfree car kit.

The primary method for disabling a fixed or portable CMT in motion is by use of speed outputs derived from the GPS receiver. Speed readings could also be taken from the vehicle odometer via connection to the serial input to the phone. One of the downsides to utilizing serial data from the odometer method is the additional wiring required at installation of the phone in the vehicle. Speed outputs from the GPS receiver (25) are taken by the microcontroller (10) and compared to the operational speed dependent conditions that have been previously set for the CMT, for example, by the user. The software allows the user to enter a range, or a number of ranges of operational speed dependant conditions that restricts use of the CMT for making and/or receiving calls. Other functionality of the phone may also be disabled under the same or other speed dependant conditions, for example, inbound and/or outbound short message services “SMS”, reminder alarms etc. As used herein, “disabling” refers to preventing an action or all actions of a certain type from being performed by, for example, setting a parameter, sending a signal, turning off a component of a device, or the like

An alternate method, to GPS or Odometer speed inputs, used to disable the CMT is to make use of the motion sensor. In some embodiments, we use the output of the motion sensor to determine if a vehicle fitted with either a Fixed In-Vehicle phone or a portable, seated in its hard-wired car kit, is stationary or is in motion. In basic applications that require simple motion—no motion parameters of use, this method is adopted given it removes the requirement of other speed based sensors. A three axis accelerometer is used to detect and measure acceleration forces applied to the CMT. With a Fixed In-Vehicle phone installed into a vehicle in this environment, the forces applied to the phone will be almost identical to that applied to the vehicle. The microcontroller (10) receives acceleration readings from the accelerometer and then compares this data with known predetermined acceleration profiles stored in non-volatile Memory. One method used to identify if the phone is in motion is to strip the gravitational component of force from the data. Once the gravitational component of force is removed from the data we are left with acceleration in the lateral or horizontal plane. Whilst gravity, in the vast majority of circumstances, is detected at 90 degrees to the horizontal plane allowance is made in the acceleration profiles for the fact that gravity is not always strictly perpendicular to the road as this relies on the road being level.

Whilst a vehicle, fitted with a Fixed In-Vehicle phone or even a handheld resting on the passenger seat or console, traveling at a constant speed in a constant direction would produce a zero acceleration result, with the exception of gravity, this could potentially allow for a “false” trigger that the phone is in a stationary state. This is overcome by not only utilizing the raw vehicle acceleration forces applied to the phone to get to this constant speed state in the first place but by also monitoring the low level vibrations or “noise” created by the road surface, wind forces on the vehicle, engine vibrations etc. This low level noise is much greater when a vehicle is in motion and almost nonexistent when stationary. It is these acceleration levels and noise detected that we can use to shut down the use of the transceiver (20) of the phone when set to do so. Once the corresponding de-acceleration and absence of any elevated level of noise is detected the transceiver (20) is then permitted to fully operate.

In addition to the setting of one or more operational speed ranges the CMT when containing map data for a particular country, state, and city can further utilize the GPS receiver to allow disabling of the mobile phone in predetermined geographic zones, often referred to as GEO-fencing. This would allow for example, the phone to be disabled in all school zones and with the additional use of the motion sensor and/or speed input the use of the phone could be limited to use in this location but whilst stationary. By utilizing preloaded, or Cellular Network downloaded, local map data, we enhance speed dependent settings to being geographically dependent as well. For example, the user may wish to have the phone disabled between 0 and 40 km/hr. This speed range would be typically used to prevent operation of the CMT in school zones. School zone speed limits apply in many places, and for example in Australia are set to 40 km/hr. Use of the speed dependant setting in this speed range would also disable the phone in slow traffic. Although this may be an acceptable compromise to some it may not be to others. Use of the preloaded map data and the GPS receiver to limit use of the speed dependant setting to when in a geographical zone or zones would then allow the device to operate within the restricted speed settings but when not located in a school zone.

To set particular speed dependant settings the user of the CMT uses the keypad (30) to navigate to the speed dependent settings menu. In this menu, a multiple of speed ranges in which the CMT is NOT permitted to operate can be entered. The software also incorporates in the menu a simple do not use “In-Motion” or do not use whilst “Stationary” setting.

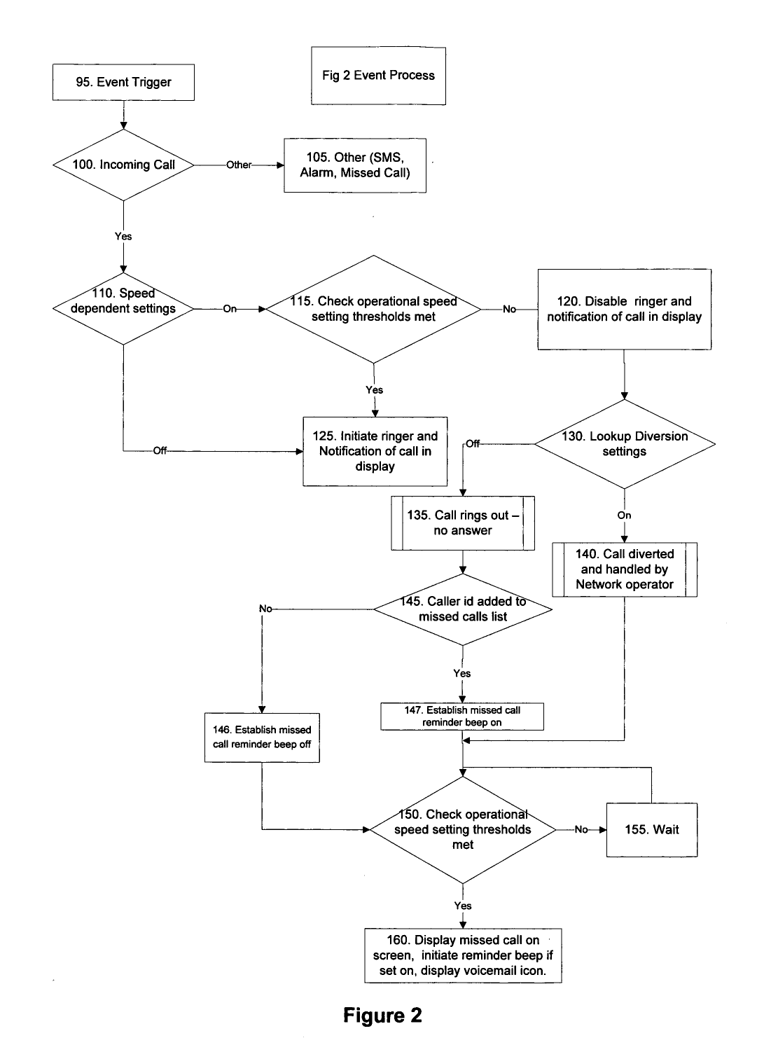

### Example Event Process—FIG. 2

Whilst one feature of certain aspects of the invention is to “disable” use of a mobile phone in a variety of circumstances, this does not entail a complete shutdown of the phone itself, although it could if required. In order to ensure facilities like emergency calls are still available to the user, the preferred method of disabling the phone is not to power down the device but to simply not alert the user of an incoming event by having the operating software simply not activate the call or other event notification in the LCD display and/or initiate any audible alerts via the phone's internal or external speakers.

FIG. 2 provides an example of a trigger event process is handled by the software. In this example the trigger event is a simple inbound call. This trigger event could be one or a multiple of event types, for example, in or outbound SMS (Short Message Service).

The mobile phone receives an incoming call (100). The microcontroller (10) upon acknowledging the status of an inbound call checks to see if there are speeds or geographical operational conditions that have to be satisfied prior to permitting the call to go through. If speed and geographical conditions (110) are turned off, the microcontroller (10) then initiates the ringer (35) and notification of the inbound call is placed in the display as per normal phone operation (125). Should the phone have one or more conditional speed and/or geographical conditions configured, the microcontroller (10) will then check to see if these operational conditions (115) have been satisfied. In order to identify if the current operational speed and/or geographical conditions have been satisfied, readings from the motion sensor and GPS are taken by the microcontroller and compared against the current stored operational conditions.

If the operational speed and geographical conditions (115) have been satisfied then the incoming call is processed by the microcontroller (10) as per normal (125). Should the operational speed and/or location conditions not be satisfied, processing continues to 120 where the microcontroller (10) would then not initiate (e.g., disable) the ringer (35), and visual notification of the inbound call would not be placed in the display (45). At this point in time, the receiving party is not aware of the incoming call. Once the phone is in this disabled state, unaware to the receiving party, the phone is still going through its normal inbound call processing. The phone, which from a call handling process point of view is technically still ringing, then looks up any current call diversion settings (130). If call diversion settings are set to off then the call rings out (135), the user is still unaware of this fact, inbound caller Identification “ID” is then added to the missed calls list, and it is determined if a call beep is on or off (145). Once the caller ID has been added to the missed calls list, a second trigger event is received, and the microcontroller (10) establishes whether the missed call reminder beep is set to “on” or “off” at step 145. If set to on (146) or off (147), this would be a third trigger event. In one embodiment, processing loops back to step 115. In an alternate embodiment, operational speed and/or location conditions (150) are then checked again to identify if the phone is in circumstances (e.g., spatial state) where it is permitted to display the missed call on the screen. The processing may wait at 155 and loop back to 150 if the thresholds are not satisfied. Once the required speed and location conditions have been satisfied, notification of the missed call is placed in the screen (45) at step 160.

Had call diversion settings been “on” at step 130, the call would have been diverted as set and the call handled by the Network Operator (140). In this “call diverted” scenario, the missed call reminder beep event process remains as previously described. An addition to this is that the inbound SMS notification received from the Cellular Network Operator, to advise the user of the phone that a voicemail has been left, will have been sent out by the Network Operator at step 140. This inbound SMS, another trigger event, may be subject to the entire speed and location dependant conditions process. Once operational conditions of the phone have been satisfied, the SMS/Voicemail icon may be displayed and any audible alert relating to the SMS may be issued.

Some of the acceleration profiles contained within the phone may be disabled or made not available to the user in terms of being switched “on” or “off”. A prime example of this is the Auto Flight Mode (“AFM”) profile. This profile is used to automatically shut down the transceiver section of the phone during take off with reinstatement of the transceiver operation not taking place until the plane has landed. A detailed description of the AFM process is detailed below.

An included accelerometer (10) within the phone provides the necessary inputs to determine the state transitions associated with AFM. The accelerometer output may be categorised in two ways: the low-pass and high-pass content. The low-pass component of the accelerometer output signal describes gross changes in vehicular movement. For example, aircraft acceleration during takeoff and landing. The high-pass component of the accelerometer output is indicative of vibration relating to the various phases of an aircraft flight, for example, during flight, vibration is caused by the aircraft engines.

The AFM detection algorithm may consist of tracking a sequence of states associated with the progression of aircraft flight. Should the battery be disconnected in an attempt to defeat AFM, the state information has been stored in non-volatile memory allowing the detection algorithm to continue upon reconnection of the battery (65).

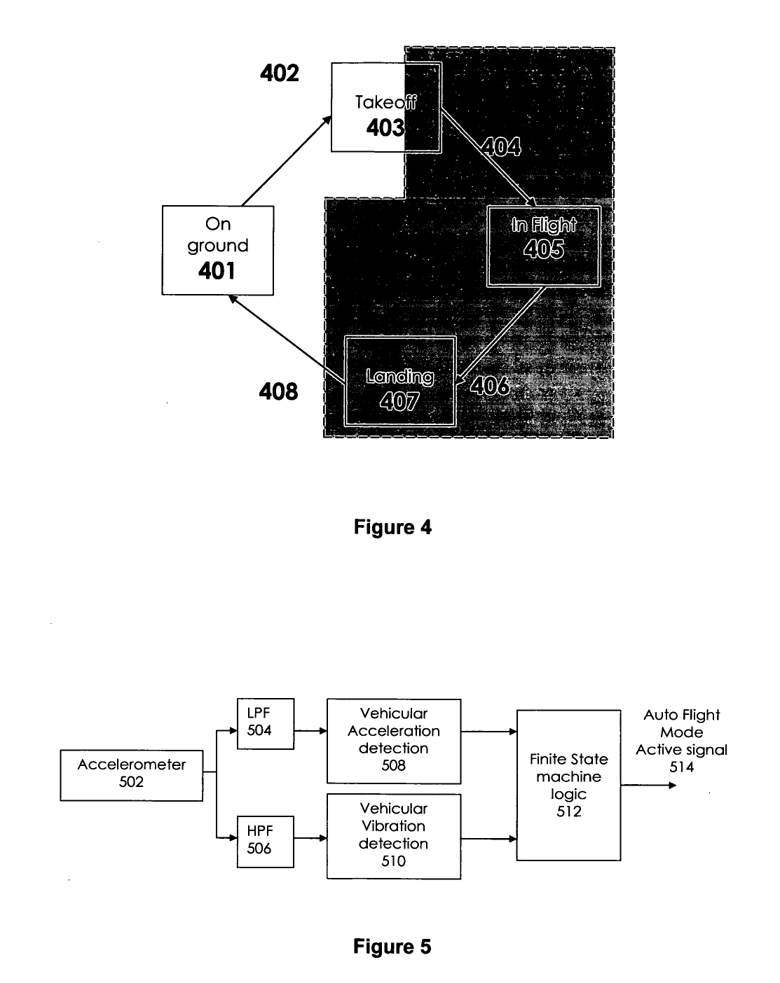

Process flow for auto in-flight (FIG. 4):
1. Prior to flight, the phone is not in AFM and is in the on ground state 401.
2. During transition 402, the detection process is in progress during the initial stages of aircraft takeoff.
3. During takeoff state 403, the conditions are detected that put the phone into AFM (shaded region).
4. During transition 404 and after takeoff, a transition is made into in-flight status/state 405.
5. During transition 406, the landing event is detected. The process then continues to landing state 407.
6. During transition 408 and at the completion of the landing event, the phone safely exits from AFM.
FIG. 5 illustrates certain embodiments in which an accelerometer (502) is used for AFM. The system includes accelerometer 502, Low Pass Filter (LPF) 504, High Pass Filter (HPF) 506, Vehicular acceleration detection 508, Vehicular vibration detection 510, and finite state machine logic 512. Finite state machine logic 512 may perform the process of FIG. 4. Accelerometer data is continually acquired from accelerometer 502 as a background task of the controller inside the phone. This enables AFM to be detected at all times. This includes when the phone is switched “off” and may include circumstances where the battery (65) is disconnected, in which case a lithium cell (70) would provide power to the AFM detection facility.

A three dimensional accelerometer within the phone is used to acquire the necessary information to implement the AFM feature. Aircraft motion is sensed by separating the acceleration data from accelerometer 502 into high and low pass frequency components using HPF 506 and LPF 504, respectively, to identify the conditions associated with the various phases of aircraft flight. The low pass derived signal describes the vehicular acceleration (508) associated with takeoff and landing as well as motion associated with turbulence. The high pass derived signal describes vibration, which is present during flight due to engines (510).

The results of 508 and 510 may be used by finite state machine logic 512 to perform, for example, the process of FIG. 4. For example, the magnitude, shape and duration of the low-pass signal form a unique class of profiles that are unique to the takeoff of fixed wing aircraft and in particular passenger jet aircraft. Once in AFM, the algorithm may ignore turbulence related accelerations these differ from a landing event profile. Finally, after landing the high pass component determines that the aircraft has landed and is at rest, or has sufficiently slowed down to exit AFM.

The methods used may discount a component of acceleration that is constant due to gravity. The magnitude of this component is typically many times greater than the component due to vehicular acceleration. However, the component due to vehicular acceleration is perpendicular to gravity and various methods may be used to differentiate these components.

One method involves combining the three axis accelerometer data with a magnitude computation. This makes the detection algorithm work independently of the orientation of the phone. For example, the phone may be horizontal, vertical, in between, and this may change at any time. The component of acceleration due to gravity is subtracted during the magnitude calculation.

Alternatively, the constant component due to gravity may be rejected with a high-pass filter function.

Another method involves tracking the vector components due to gravity and the perpendicular components due to motion separately.

The conditions of entry to AFM require a Vehicular acceleration in magnitude and duration beyond what is possible or likely in other forms of transport.

The condition necessary to remain in AFM include high magnitude vehicular acceleration events, such as those experienced due to turbulence, as well as a vibrational signals that are normally present during flight. Conditions necessary for the termination of AFM include a period of absence of vibration.

Vibration detection may be enhanced with audio data collected via the phone's microphone. Components of the vibration due to engine noise may be detected with band-pass filter in combination with level detector or Fast Fourier Transform to identify noise and vibration.

In any case, finite state machine logic 512 may produce an auto flight mode active signal 514 that identifies which states and/or transitions from FIG. 4 that the phone is in.

An additional acceleration profile contained within the phone also not seen or selectable by the user is a “Warranty Validation Profile”. With the use of the accelerometer (10,502) we can detect free fall, zero G force; once this free fall event is detected an event logging process is started within the phone. The duration of the free fall event, and the subsequent level of G force applied to the phone on impact, is logged, stored in non-volatile memory, and is made available for retrieval at a later date to an authorised phone service or repair facility. Other forms of potential product abuse are also detected i.e. when someone throws the phone or the moment the phone leaves the user's hand, free fall is detected and the logging process is initiated. The main difference between a person dropping the phone and throwing it is the increased forces applied to the phone prior to it leaving the personas hand. The prime purpose of this detection process is to log how many times the phone has been dropped and/or thrown. The Warranty Validation Profile runs as a background task even if the phone is switched off.

In some embodiments, a CMT according to the present invention (5) may also incorporate a pressure sensor and/or temperature sensor (60). One purpose of the pressure sensor and/or temperature sensor is to take current temperature readings and then display the current temperature on the LCD display (45). Display of the ambient temperature is optional and user selectable. Remote retrieval of temperature data from the phone is also available via interrogation of the phone via a data call, SMS, or other packet data session. A pressure sensor may also be used in ways described below and to enable display of pressure readings on the LCD display. Remote retrieval of pressure data from the phone is also available via interrogation of the phone via a data call, SMS, or other packet data session.

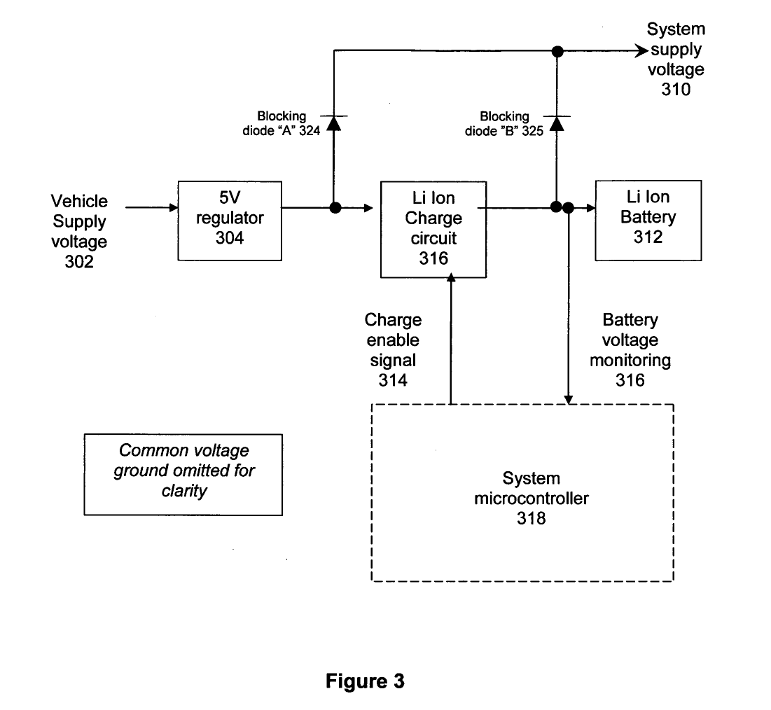

Fixed In-Vehicle Phones may draw their power from the vehicles electrical system. In one embodiment, a Fixed In-Vehicle version of the phone comprises an Internal “Back up Battery” (65). One of the downsides to not having a back up battery in a Fixed In-Vehicle is that it can render the phone inoperable in the event of a vehicle accident that cuts power to the phone. Even a general electrical breakdown of the vehicle would also render the phone inoperable. Both of these circumstances are ones where the need to use the Fixed In-Vehicle phone would be paramount. For this reason in some embodiments of the invention, the Fixed In-Vehicle phone comprises an internal Back Up Battery. In preferred embodiments, the circuitry design of the power section of the phone allows for full operation of the installed phone with or with out the internal back up battery installed. This is vital in some industries, in which a vehicle is not permitted to be used with a phone containing an internal battery. This scenario also eliminates the use of a portable phone with a battery. This power circuitry layout also means that a Portable version of the phone would operate in a Fixed In-Vehicle car kit with the battery removed. This would allow the portable phone to be used, with battery removed but placed in its hardwired car kit. See for example, FIG. 3.

In one embodiment of the invention there is provided a communications device comprising a motion sensor to measure changes in forces applied to the device. The motion sensor may take any suitable form, and may for example, comprise an accelerometer and may, for example, measure the rate of change, in forces applied to the device.

In another embodiment of the invention there is provided a communications device comprising a motion sensor to assist with tracking and location of the device. A motion sensor according to this embodiment of the invention may be used in conjunction with or in the absence of other location methods such as a Satellite Global Positioning Systems “GPS” or Radio Triangulation via a Cellular Network Transceivers (which is often referred to as(Location Based Services “LBS”). A motion sensor according to this embodiment of the invention may be used to measure and determine turn angle and the rate of turn applied to the device.

In one embodiment of the present invention, there is provided a communications device comprising a sensor to receive data relevant to the relative height of the device as compared to another device or point in space and a data storage mechanisms to store the data. In some embodiments, there is further provided a processor which is adapted to calculate from the data the relative height of the device as compared to another device or point in space. In other embodiments, the processor is separate from the device, and may, for example, comprise a separate computer which may, for example, be in communication with the device, for example, by a communications network.

Any suitable mechanism or method may be used to calculate the relative height of the unit.

In some embodiments of the invention, the sensor is an altimeter which may record and log the altitude, for example, by recording the ambient barometric pressure at predetermined intervals for retrieval if and when required.

In other embodiments of the invention, the point in space in relation to which the relative height is calculated comprises a local weather station from which cross-reference weather data or barometric data may be collected. In a further embodiment of the invention, one or more devices (such as mobile phones) may be used as a reference point. In some of these embodiments, the other devices act as a reference weather station.

In one embodiment of the present invention, there is provided a hand-held communications device comprising an electromagnetic shield to restrict transmission of electromagnetic radiation towards a body part of the user. A shield according to this embodiment of the invention may comprise any suitable form, for example, it may comprise electromagnetic field reflecting, inhibiting and/or absorbing material. The shield may protect any suitable body part, and in some preferred embodiments, it is the head.

In one embodiment of the present invention, there is provided a fixed-In-Vehicle communications device comprising a back-up source mechanism to provide power in the event of loss of power from the vehicle.

According to one embodiment of the present invention, there is provided a fixed-In-Vehicle communications device comprising an internal antenna. A unit according to this embodiment of the invention may still operate on a cellular phone network even in the event that the externally mounted cellular antenna is unable to be used, for example, if it is removed, stolen, faulty, or damaged.

According to one embodiment of the present invention, there is provided a fixed-In-Vehicle communications device comprising software and/or hardware to monitor the vehicle's electrical systems, such as the vehicle battery condition.

In one embodiment of the invention, there is provided a communications device comprising text-to-speech functionality in which text displayed in the screen of a unit, such as a mobile phone is converted to speech. Any item of text that appears in the screen may be selected or preselected by the user to be converted to speech. Such text to speech functionality may be used for any of the normal functions of the unit. In some embodiments, the user may have the unit read text messages (such as sms or email) aloud. In some embodiments the unit is a Fixed In-Vehicle or a portable mobile phone fitted into a hardwired hands-free kit.

In one embodiment of the invention, there is provided a communications device comprising an interchangeable portion so as to enable the same basic unit to become a fixed-In-Vehicle or a handheld unit. In some embodiments, the interchangeable portion comprises the rear cover. The interchangeable portion according to this embodiment of the invention may take any suitable form.

In one embodiment of the present invention, there is provided a communications device comprising a floatation component. The floatation component may form any suitable part of the unit, and in some embodiments it comprises the cover and may, for example, comprise a compartment within or defined by the cover. In some embodiments, the floatation component comprises trapped air, or a material of lower density than water, such as, for example, polystyrene foam.

In one embodiment of the present invention, there is provided a communications device comprising software and/or hardware adapted to render the unit inoperable under certain conditions. Thus, for example, the unit may be set not to make or receive calls at, above or below user-defined vehicle speeds. Similarly, the unit may be forced to shut down completely or remain logged on to a cellular network but not allow the user to use some or all of the phones functions. The speed of the unit may be determined by any suitable mechanism, for example, GPS, interfacing of the phone to a vehicles odometer, or by the use of an accelerometer within the phone or a combination of one or more of these methods.

According to one embodiment of the invention, there is provided a communications device comprising an SMS disabling function. In some embodiments, SMS disable features may also be dependent on or used with the user defined vehicle speed conditions. In some embodiments, a combination of one or more of the above features may be used.

In one embodiment of the invention, there is provided a communications device comprising multiple SIM card capability, and wherein different call types or phone numbers may be tagged to a particular SIM card without the need to manually select which SIM the user wishes to use.

In one embodiment of the invention, there is provided a communications device comprising voice recognition software that allows some or all of the unit's features to be used by one or more authorised users depending on the user's voice signature or imprint.

According to one embodiment of the invention, there is provided a communications device comprising a battery which is able to be charged inductively. This embodiment allows the design and construction of the outer casing of the phone to have no external metal connectors for charging of the battery. Such a design is particularly important for the design of units such as mobile phones to be used in Hazardous environments such as Gas and Petrochemical production plants etc.

In one embodiment of the present invention, there is provided a communications device comprising a visual display function, such as a flash sequence function responsive to a device function or event. In some embodiments comprising a flash sequence function, the device's, various predetermined sequences of lighting for the back lighting of the device may be created by the user and then linked to certain functions, or event occurrences. Individual flashing sequences may, for example, be assigned to certain names stored in the phones memory or on the SIM card. A certain flash sequence may be used just to identify an incoming SMS Text message from a known party. In other embodiments, the unit's screen may display a variety of pictures which correspond to the various functions or event occurrences.

In one embodiment of the invention, there is provided an accessory for use with a communications device wherein the accessory enables a duress or emergency signal to be sent from the device. In some embodiments, the accessory is a low power radio transceiver.

In one embodiment of the invention, there is provided a communications device comprising software that allows the use of one or more existing buttons on a commonly available wireless accessory to a mobile phone, to be used to trigger an emergency duress alert phone call, SMS message or both. The alert or alerts may be sent via one or more communication methods available to the phone but most commonly via SMS, standard cellular phone call, packet data or a combination of one or more of these methods. Wireless accessories for use with this embodiment of the invention may, for example, be low power radio transceivers used for hands-free operation such Infrared, Zigbee, and Bluetooth etc.

In one embodiment of the invention, there is provided a communication device comprising a receiver, a transmitter and a processor and further comprising a safety feature to increase the safety of the user. In some preferred embodiments, the safety feature comprises a location feature, such as a motion sensor, altimeter, accelerometer, gyroscope, GPS, etc.

Certain of the features of the present invention relate to the safety and/or location of the user. Such features are useful in many ways. For example, many industrial occupations, such as vehicle driving, forklift driving, fire fighting, ambulance, police, manufacturing plant operation, etc would greatly benefit from the addition of such features to a communication device.

Some features of the current invention include:
1. Incorporation of an acceleration measuring motion sensor into a fixed or portable unit;
2. Incorporation of a motion sensor into a fixed or portable unit that allows dead reckoning and inertial navigation calculations and measurements to be made;
3. Incorporation of an altimeter, and/or other altitude-sensing device, into a fixed or portable unit;
4. Use of an electromagnetic shield in or on the outer front cover of a portable unit;
5. Incorporation of an internal backup battery in a Fixed In-Vehicle unit;
6. Incorporation of an internal antenna into a Fixed In-Vehicle unit;
7. Incorporation of software and hardware within a Fixed or Portable unit to monitor a vehicles electrical systems, including but not limited to, vehicle battery condition;
8. Incorporation of software and hardware in a fixed or portable unit to provide the conversion of text, displayed in the screen of the unit, to Speech;
9. Design of an Interchangeable set of rear covers for a unit for the conversion from a handheld portable unit to a Fixed In-Vehicle unit and visa versa;
10. Floating portable unit
11. Incorporation of software and/or hardware in a unit that renders the unit inoperable when a vehicle is in motion at, above, below or within a range of a user defined vehicle speed conditions;
12. Incorporation of software in a unit that allows the user to disable use of either inbound or outbound Short Message Service “SMS” or both;
13. Incorporation of software in a unit fitted with Multiple Sim card capability, that allows stored phone book entries in the unit's memory to be assigned or tagged to an individual SIM card;
14. Incorporation of voice recognition software within a fixed or portable unit that allows some or all of the unit's features to be used by one or more authorised users where the unit has the user/s voice “signature or imprint” registered on the unit;
15. Inductive charge of the battery within a unit;
16. Flash Tones—Incorporation of software and hardware in a fixed or portable unit to allow user defined flash sequences of the back lighting of a unit to be created and assigned to various functions within the unit;
17. PEDA—Personal Emergency Duress Alarm—Device
18. PEDA—Personal Emergency Duress Alarm—software

Moreover, the mobile devices, including the portable and fixed/mounted devices can use various sensors for performing the processes of the invention, including a motion sensor, a GPS, a speedometer, or a pressure sensor. In one embodiment, disabling a phone in a basic motion or a no-motion state may utilize the sensors. A mechanism to disable the phone in a basic motion/no-motion condition for the Fixed In-Vehicle version of a phone is to use the accelerometer. A mechanism to disable the phone in a basic motion/no-motion condition for a portable version of a phone is to use GPS. Serial Communication (Speedometer Information) may be used with an In-Vehicle version of the phone and a portable version when it is seated in to a hard-wired in car kit. Disabling a phone via speed dependant conditions may use the motion sensor as a complimentary mechanism, GPS as a primary mechanism, and the speedometer as a supplementary mechanism. Disabling a phone in geographical locations may use the motion sensor as a complementary mechanism and GPS as a primary mechanism. Disabling a phone in geographical locations with speed dependant conditions may use the motion sensor as a complementary mechanism, the GPS as a primary mechanism, and the speedometer as a complementary mechanism. Disabling a phone via Auto Flight Mode Profile may use a motion sensor as a primary mechanism. Determining a Warranty Validation Profile may use the motion sensor as a primary mechanism. Displaying a current temperature may use the pressure sensor as a primary mechanism.

Incorporation of an Acceleration Measuring Motion Sensor into a Fixed or Portable Unit:

In another embodiment of the invention, a motion sensor, typically an accelerometer, is incorporated into a fixed or portable communications device or unit to measure changes, including the rate of change, in forces applied to the unit. Such measurements can be used, for example, to help determine if the user, for example, has fallen over, been in a vehicle based crash i.e. car, truck, bus, train, boat, elevator etc.

In embodiments comprising fixed and portable radio telephones such a feature can also be used to trigger an alert via communication methods available to the radio cellular telephone, such as SMS, mms, cellular phone call, data call, Bluetooth etc. should motion be detected in circumstances when it shouldn't be. Thus, for example, such a communication may be triggered when the phone is in safe or armed mode in a vehicle that should be stationary. The device may, for example, detect motion and then an Alert (by voice, data, sms, etc) may be issued to a predetermined number, or a series of numbers, contained within the phone, making contact with a security company, roadside assistance organization, emergency organization, etc.

Such a motion sensor may also be used to determine if the user of the radio cellular telephone has abused the product or dropped it with enough force to damage the product internally with minimal physical evidence of abuse externally. Such electronic logging of forces may be used in warranty failure validation to help determine whether a product failure was cause by user abuse, thus helping minimise any product warranty claims or exposures.

In such embodiments, the detection of absence of motion may also be useful. The radio telephone when placed in a mode to alert when zero motion is detected for a user defined period of time would be used for example; in the event that a fireman is located in a building and zero motion is identified for a greater period than the predetermined set period of time this trigger point could then be the basis for an alert to be issued to one or more devices of this non motion event. This non motion alert potentially identifying that the fire fighter equipped with the portable radio telephone may be injured and/or trapped thus allowing assistance to be rendered immediately.

Any suitable type of accelerometer may be used in embodiments of the invention. Thus for example, in some embodiments, the accelerometer comprises one or more of PCB Piezotronics Models 352A73; 352C23; 357A08; ADXLxxx series, STM LIS302, LISxxxx series, Freescale MMA1260,MMAxxxx series, Oki ML8953, Colibryis MS8000, TronicsMicro and/or Analog devices, such as ADXL330.

Incorporation of a Motion Sensor into a Fixed or Portable Unit that Allows Dead Reckoning and Inertial Navigation Calculations and Measurements to be Made:

In another embodiment of the invention, a motion sensor is incorporated in a unit, such as a radio cellular telephone to assist with tracking and location. Collected data is used to make calculations in relation to the positioning of the device. A motion sensor according to this embodiment of the invention may be used in conjunction with or in the absence of other location methods such as a Satellite Global Positioning Systems “GPS” or Radio Triangulation via a Cellular Network Transceivers (which is often referred to as Location Based Services “LBS”).

A motion sensor according to this embodiment of the invention may be used to measure and determine turn angle and the rate of turn applied to the unit, which may be a fixed or portable radio cellular telephone. This is of particular value when other device tracking methods such as GPS and/or LBS fail or are unavailable. Thus, with the present embodiment of the invention, speed and heading of the unit may still be determined and logged even if the unit should experience a loss of either GPS and/or LBS radio signals. Such a feature would have particular utility for example, should the device enter a road tunnel, rail subway, building or other urban or natural canyon environment.

In some embodiments, the unit (such as a Fixed In-Vehicle phone or a Portable Mobile phone (when in its car kit)), may be equipped with sensory inputs to allow connection to and logging of odometer readings from a vehicle. Odometer readings may be used in combination with a motion sensor to assist in determining distances travelled.

Any suitable motion sensor may be used in embodiments of the invention. Thus for example, in some embodiments, the motion sensor is a gyroscope for example, a piezoelectric gyroscope such as NEC's Model CG-L53, Murata ENC03, Inven IDG300, STM LIS1R02, Dephi RV200L, SiliconSens CRS07, TronicsMicro and/or Analog devices such as ADXRS300.

Incorporation of an Altimeter, and/or Other Altitude-Sensing Device, into a Fixed or Portable Unit:

In another embodiment of the present invention, there is provided a mechanism to calculate, or to assist in the calculation of, the relative height above or below sea level or another predetermined relative height reference of the unit (which may, for example, be a fixed or portable device such as a radio cellular telephone).

Any suitable mechanism or method may be used to calculate the relative height of the unit.

In some embodiments of the invention, an altimeter fitted to the unit may record and log the ambient barometric pressure at predetermined intervals for retrieval if and when required. Such data may, for example, be available to be retrieved from a remote computer system. In such embodiments, the altitude and/or other location data from the phone may be retrieved via various communication methods available to the phone. This may, for example, be via data sent via SMS or via packet data call. The barometric pressure is then cross-referenced with the known barometric pressure from within the city or area in which the phone is located. Barometric pressure details are generally available from a local weather bureau. A computer server using proprietary software may then compare the local barometric pressure of the town in which the phone is being used with the barometric pressure reading or readings from the mobile phone itself to then determine the height of the phone.

In other embodiments of the invention, a local weather station may be installed from which cross-reference weather data can be collected. This embodiment is particularly useful where altitude information is required in a city or other location in which standard weather bureau readings are not available. Such a weather station could be one of a number of commercially available units and, for operation of the invention may be able to communicate the collected data, and preferably via a communications device, be it hard-wired or wireless. A weather proof permanently mounted version of the device fitted with the altimeter may also be used as a reference station for barometric pressure. According to this embodiment, a computer system requests a barometric pressure reading from the fixed weather station and then compares this to the readings from the mobile phone to thereby calculate the height of the unit relative to the height of the fixed point (such as a weather station).

In a further embodiment of the invention, one or more units (such as mobile phones) may be used as a reference point (such as a weather station). This embodiment is useful where two or more mobile phones fitted with an altimeter and relevant software are used within the same local area. Any phone according to this embodiment of the invention may be used as the prime or reference weather station. The prime unit may be used to retrieve pressure and/or other location data from one or more phones within a group. The prime unit may, for example, be at ground level at the scene of a fire in a multi-storey building and the other phones with firemen located on the same or different floors of the building. The prime phone may then retrieve barometric pressure data from the two units in the building and use these readings to cross-reference them with the readings from the prime unit to make height calculations.

For optimum use of barometric pressure-based altimeters in such an example (which includes proximity to heat such as from a fire in a building), the unit will additionally comprise a temperature sensor to collect temperature data. The temperature data will optimally be used to adjust the barometric readings which would otherwise be unreliable due to the effect of heat on the pressure measurement.

In a still further embodiment of the invention, altitude is logged over a period of time, within a single unit (such as a phone). Preferably, the volume of data stored is limited by the available memory capacity of the phone and the time interval between each barometric pressure record logged. Such data may, for example, then be retrieved and altitude calculations made with the series of data collected. In some embodiments, the data is remotely retrieved to a separate computer system.

Such collected data may assist to determine height above or below ground level. A method according to this embodiment is optimally combined with other tracking and location methods to improve accuracy. Combined with such other methods, the method of this embodiment is still very useful in helping determine the height of the unit and its user.

In one example, if the Cell ID from a cellular network is logged over the same period of time as the logged altitude measurements, using the triangulation of the cellular network we can determine the approximate locations that the phone has travelled for that period of time.

Thus, by way of example, a four hour period may be selected and from the cell site ID's it is known that the user is in the city area of the Gold Coast, Queensland Australia. For the sake of this example, it is also assumed that local barometric pressure is not available via a weather bureau or alternative remote weather station. Whilst in this example it is not possible to obtain actual local ground level based barometric pressure measurements, it is still possible to make various determinations based on the data received from the phone.

Thus, for example, during the first three hours of the four hours logged, the phone covered a distance of 12 km and altitude varied by 50 meters, and the time taken to cover the 12 km was 12 minutes. From this, it can be determined (i) the phone and user are travelling at an average speed of 60km per hour and (ii) are most likely in a motor vehicle should no rail or watercraft operate in the geographical location of the tracked phone.

If within the last hour, the logged barometric pressure indicates a sudden rise of say 150 meters in less than 2 minutes and no variation thereafter, and the Cell site base locations of the phone have also indicated minimal movement, it can then be determined that the phone and user have travelled in a lift to this height and remained at this height for the balance of the hour.

Should GPS also be fitted to this particular phone and its data logged over the same period this would provide much greater accuracy of the location data retrieved from the phone and we would then know exactly the roads the user travelled on. This would also give us a Ground Level or Base reference point to match with the altimeter readings for the phone.

Should the phone also be fitted with a gyroscope, then this would allow tracking of the phone in periods of poor or no GPS coverage. This would allow tracking of the phone and user into the tall buildings.

Should the phone also be fitted with an accelerating motion-sensing device it would be possible to also log the acceleration from the upward motion in the lift.

The pressure sensor data in the phone would also note and log the pressure differential between the outside and the inside of the lift well within the building further confirming the determination that the user of the phone had entered a lift.

Any suitable altitude-sensing device may be used in embodiments of the invention. Thus for example, in some embodiments, the device is a barometric altimeter, a radar altimeter, and may be GPS-based, Freescale MPX2100A, MPX5100A, MPXxxxx series, Si Micro SM5818015A5, VTI SCP1000, SPCxxxx series and/or TronicsMicro, etc.

### Incorporation of an Electromagnetic Shield in or on the Front Cover of a Handheld Unit:

In another embodiment of the present invention, there is provided an electromagnetic shield on one side of a handheld unit to restrict transmission of electromagnetic radiation towards a body part of the user. This embodiment of the invention may significantly reduce the Specific Absorption Rate “SAR” rating of a unit such as a mobile radio cellular telephone. A shield according to this embodiment of the invention may comprise any suitable form. For example, it may comprise electromagnetic field reflecting, inhibiting or absorbing material. The shield may protect any suitable body part, and most preferably, it is the head.

In some embodiments, the front cover of a handheld unit (such as a radio cellular telephone) comprises the shield. In some embodiments, the shield comprises material which inhibits, reflects or absorbs electromagnetic radiation, such as radio frequency signals. In this embodiment, the rear cover does not contain such electromagnetic reflecting, inhibiting or absorbing material so that the radio signals being transmitted and/or received by the mobile device are, not compromised.

The electromagnetic absorbing, reflecting or inhibiting material may be used in any suitable configuration. For example, it may be mixed with the original front cover case compound, normally plastic, of the mobile phone. The material may also be coated on the inside or outside of the front case or both. A combination of coatings on the inside and outside of the front cover plus a additional electromagnetic inhibiting compound material with in the case construction may be used.

Any suitable electromagnetic shield may be used in embodiments of the invention. The shield may, for example, comprise: an RF shield, sheet metal, wire mesh, metallic ink (such as copper or nickel metallic ink), one or more polymer or composite materials, etc or any combination thereof.

In some embodiments, the shield is produced from a spray-on coating which may take any suitable form, for example, a nickel metal coating. Thus, in some embodiments, a product such as “compliance in a can” (Electrolube), can be used. Thus, a sprayed coating of such a product may be applied to the inside and/or outside cover of a unit such as a mobile phone. In some embodiments, the spray may be applied to the inside and/or outside of the lower half of the rear cover but at the same time making sure that this material is not used in an area of the mobile phone case that would impede the performance of the mobile phones antenna.

In other embodiments, the shield may be created by impregnating at least a portion of the case of the unit with a shielding material. Thus, for example, a plastic case may be impregnated during its manufacturing process with, for example, a compound of either nickel and/or silver powder to reduce EMI emission from the unit or phone. In some embodiments, a conductive thermoplastic is used, such as a Premier™ thermoplastic (EMI Products). Such a conductive thermoplastic may be of any suitable type, for example, a polycarbonate plastic. In some embodiments, a combination of shielding methods may be used, for example, a combination of both spray and embedded compounds.

### Incorporation of an Internal Backup Battery in a Fixed In-Vehicle Unit:

In another embodiment of the present invention, power is provided to a Fixed In-Vehicle unit such as a phone, even in the event of loss of power or external electrical system failure of the vehicle. The vehicle may be of any suitable type which may be fitted with a communication unit.

Prior art car mounted or aftermarket Fixed In-Vehicle mobile cellular telephones that are hardwired into a vehicle draw power from the vehicle battery. These types of mobile phones do not have an internal back up power source should the vehicle's battery power become unavailable, such as when the battery is flat, the electrical system fails or there is a collision.

An internal back up battery may have sufficient capacity not only to back up data within the phone but to also power the phone for use, preferably in hands-free mode. For example, by making use of the external speaker and microphone attached to the phone as installed into the vehicle.

A back up battery according to this embodiment may also be mounted within the phone casing to provide further physical protection to this power source in the event of a vehicle accident. In some embodiments, the backup battery may be constantly charged when the vehicle is in use.

In some embodiments, the internal back up battery allows full operation of all of the phone's features in the event of the loss of external power source. This may, for example, include the making of emergency phone calls and/or accident triggered automated calls or alerts sent via SMS or packet data. Such messages, and particularly those which are automated may preferably also contain other useful information such as location information.

Any suitable battery may be used in embodiments of the invention. Thus for example, in some embodiments, the battery may be a “lithium polymer” 1700 mah mobile phone battery. Some embodiments may use a lower capacity as the battery may be for back up purposes. In some embodiments, a “Lithium Ion” mobile phone battery may be used. Similarly, Nickel Cadmium and Nickel Metal Hydride could also be used. However, these are older battery technologies and suffer from the “Memory Effect” which may make them less suitable in an environment where the battery is getting a top up charge very frequently each time the vehicle is in operation.

In one embodiment, the Fixed In-Vehicle phone uses and senses constant power to run the phone. When the external constant power source is removed it automatically switches to the internal back up battery. The circuit diagram for this is shown on FIG. 3. FIG. 3 shows, among other things:
When vehicle power supply 302 is connected, diode A 324 conducts current to power the system 310.
When vehicle power supply 302 is removed, diode B 325 conducts current to power the system 310.
Charge circuit 316 is enabled by the system microcontroller 318 as required by charge enable signal 314.
Voltage feedback is available to the system microcontroller 318 to monitor the battery condition, or presence at battery voltage monitoring 316.
If the Li Ion battery 312 is removed the system may still get power from vehicle supply 302.

In another embodiment, the phone (fixed or Carkit mounted) is configured to detect constant power from the vehicle to both power the phone and charge its internal battery. The phone may be configured to operate above 3 volts and/or be inoperable on less than 3 volts. The phone may be configured to monitor the voltage from the vehicle (e.g., 12-13.8 volts for a car battery and 24 volts for a truck). The phone may be configured to detect lower than normal voltage thresholds from the vehicles battery. In one embodiment, 8 volts and 16 volts may be the default low battery alert thresholds. Additionally, the phone may be configured to, over time, detect a slow decline In-Vehicle battery condition.

Incorporation of an Internal Antenna into a Fixed In-Vehicle Unit:

According to another embodiment of the present invention, there is provided a Fixed In-Vehicle unit, such as a mobile phone comprising an internal antenna. A unit according to this embodiment of the invention may still operate on a cellular phone network even in the event that the externally mounted cellular antenna is unable to be used, for example if it is removed, stolen, faulty, or damaged.

Units according to this embodiment of the invention have particular utility in the common situation in which an external antenna is damaged by low tree foliage which overhangs a roadway. Thus, with this embodiment of the invention, the user will still have access to the communications network, via the internal antenna.

In some embodiments, the internal cellular antenna is fitted within the casing of the Fixed In-Vehicle unit (such as a phone) to provide greater physical protection in the event of a motor vehicle accident.

Any suitable internal antenna may be used in embodiments of the invention. Thus, for example, in some embodiments, the internal antennae may comprise one or more of: Antenove Quadnova, Pentanova, Flavous, Skycross EM-xxxx series, Taoglas PC2704, PCxxxx series, Ethertronics IMD series, etc.

Incorporation of Software and Hardware within a Fixed or Portable Unit to Monitor a Vehicle's Electrical Systems, Including but not Limited to, Vehicle Battery Condition:

According to another embodiment of the present invention, the unit is provided with software and/or hardware to monitor one or more of a vehicle's electrical systems, such as the vehicle battery condition.

In some embodiments, the unit comprises a fixed, or portable mobile phone placed in a hardwired hands-free kit that is adapted to monitor the condition of the vehicle battery. In such embodiments, the mobile phone, via its fixed installation or connection via a hardwired hands-free kit (in the case of a portable), monitors the voltage output of the automobile battery at regular intervals. Should a drop in voltage be detected that might potentially be detrimental to the operation of the vehicle, an alert via one or more of the communication methods available to the mobile phone may be sent out to a pre-determined phone number or series of phone numbers selected and stored on the phone by the user. This is a proactive system as it is designed to notify the owner or anyone involved with the maintenance of the vehicle that the battery is losing condition so it can be replaced prior to a potential “Flat Battery” incident. A poor vehicle battery condition alert notification may also be displayed in the screen of the mobile phone.

This embodiment of the invention is also very useful in other circumstances. For example, it may be used to provide an alert (for example by phone message, sms, email, etc) if the vehicle's lights are inadvertently left on. It may also be connected to and communicate information in relation to any other electronic or computer system of the car and may communicate the information to any suitable party, such as the manufacturer of the vehicle, or a service provider charged with maintaining the vehicle.

In some embodiments in which the unit comprises an internal back up battery, the unit still has the ability to send such reminder or alert messages or make alert data calls even in the event that the vehicle battery is completely exhausted. A portable in its hardwired Handsfree car kit may also provide the alerts given it has its own internal battery.

This embodiment of the invention may also be used with or without Cellular location based services and/or onboard GPS data logged by the phone to provide the location details of the vehicle to a third party such as an emergency or roadside assistance organisation to render assistance.

Any suitable software and/or hardware may be used in embodiments according of the invention.

### Incorporation of Software and Hardware in a Fixed or Portable Unit to Provide the Conversion of Text, Displayed in the Screen of the Unit, to Speech:

In an embodiment of the invention, text displayed in the screen of a unit, such as a mobile phone is converted to speech. Any item of text that appears in the screen can be selected by the user to be converted to speech. Such text to speech functionality may be used for any of the normal functions of the unit.

In some embodiments, the user may have the unit read text messages (such as sms or email) aloud. In some embodiments the unit is a Fixed In-Vehicle or a portable mobile phone fitted into a hardwired hands-free kit.

Having the Text or SMS messages “read out” to the driver of a vehicle in motion provides for a much safer operation of the vehicle, and phone, than the potentially dangerous practice of the driver attempting to read the messages whilst driving. This is particularly the case with a Fixed In-Vehicle phone that cannot be removed from its mounted location. The ability for the phone to read out text messages is just as important for a portable phone which may, for example, be fixed within a hardwired hands-free car kit as usually a driver will remove the phone from the car kit and attempt to read the message whilst driving. Although in many countries this practice may be illegal it occurs very frequently and is dangerous. The text to speech conversion of a text message eliminates the need to remove the portable phone from its hands-free cradle.

As stated above, the text-to-speech function may be used with any of the features of the unit. Thus, for example, Text contained within a mobile phone's menu system may also be read out to allow the user to navigate the menu system without having to actually look at the phone. This extends to the names contained within a phonebook list stored in the phones memory or contacts stored on the SIM Card or both.

In some embodiments, the text-to-speech function is user selectable. In some embodiments, other user defined text to speech functions may be set to occur automatically under certain circumstances. This may include for example, automatic reading out of inbound SMS Text messages under certain conditions—for example when a portable mobile phone is mounted in its hardwired hands-free kit.

In some embodiments, the device also comprises a motion sensor and the text-to-speech functionality is automatically triggered if the device is travelling above a certain predetermined speed.

Any suitable text-to-speech software may be used in embodiments of the invention. Thus, in one embodiment, the software is Smart Hal (Dolphin Computer Access Ltd). In other embodiments, the unit comprises a chip with pre-loaded text-to-speech software. Any suitable chip may be used, which may, for example, be a DSP chip with appropriate software, for example: Winbond WTS701, Texas Instruments, Analog Devices, Motorola, Microchip and Sensoryinc.

Design of an Interchangeable Set of Rear Covers for a Unit for the Conversion from a Handheld Portable Unit to a Fixed In-Vehicle Unit and Visa Versa:

In another embodiment of the invention, the rear cover of the unit is interchangeable so as to enable the same basic unit to become a Fixed In-Vehicle or a handheld unit. Rear covers according to this embodiment of the invention may take any suitable form. Thus, for example, the fixed-In-Vehicle version may comprise a connector to fixedly engage with the fixed-In-Vehicle system. The mechanism by which the rear cover is interchanged may be of any suitable type. In some embodiments, the mechanism enables fast interchangeability, but in others, it is designed to be slow (for example, to discourage theft or out-of-vehicle use of units intended to stay within the vehicle).

### Fixed to Mobile:

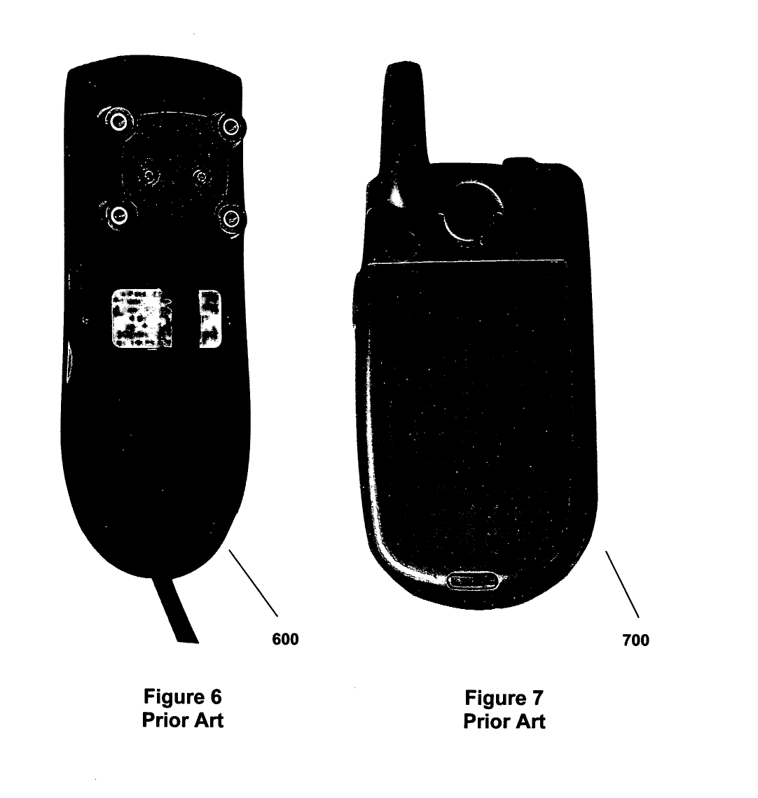

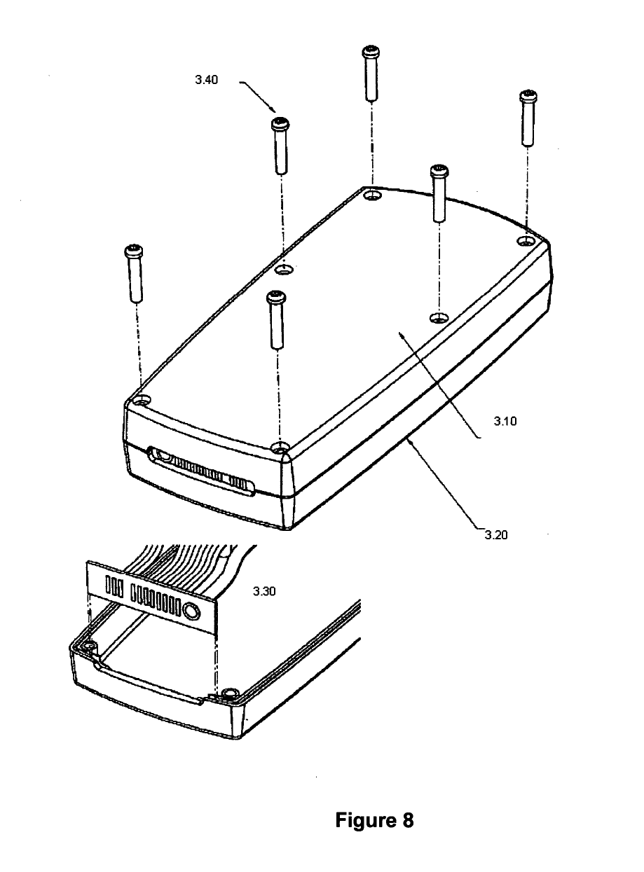

The concept of the interchangeable mobile phone case design involves the designing of one mobile phone to effectively make two very different mobile phone products. Currently Fixed In-Vehicle mobile phones can be purchased (FIG. 6) and portable mobile phones (FIG. 7) can be purchased. At this present time no mobile phone can be switched between the two versions, i.e. being a portable version then switched to a permanently vehicle mounted version by the user. This case design overcomes this problem by using the same phone for both purposes, by employing an optional or interchangeable back that is designed and manufactured for the same phone.

This case design concept provides a manufacturer of mobile phones a financial benefit due to manufacturing economies of scale. The mobile phone manufacturer would also save significant costs in R&D and Manufacturing by having to design and produce a single phone with optional backs than bear the cost involved by designing two individual and separate products.

The end consumer also benefits should circumstances change and they need to move from a permanent mount mobile telephone to a portable mobile phone and visa versa.

For example, in the road transport industry in many countries, some market sectors must by law, have a Fixed In-Vehicle phone and are not permitted to carry a portable mobile phone. This is very evident in the petrochemical & dangerous goods transport industry.

Transport companies are however continually winning and losing transport contracts. These changing contracts will mean the transport operator and the owner of the mobile phone currently needs to Switch between fixed and portable products. Until now this has been at the expense of having to purchase a whole new Mobile Phone. With the interchangeable case design concept the owner may purchase the optional back kit, at a fraction of the cost of a new mobile phone. The owner can now convert his mobile from portable to fixed or visa versa at anytime he chooses.

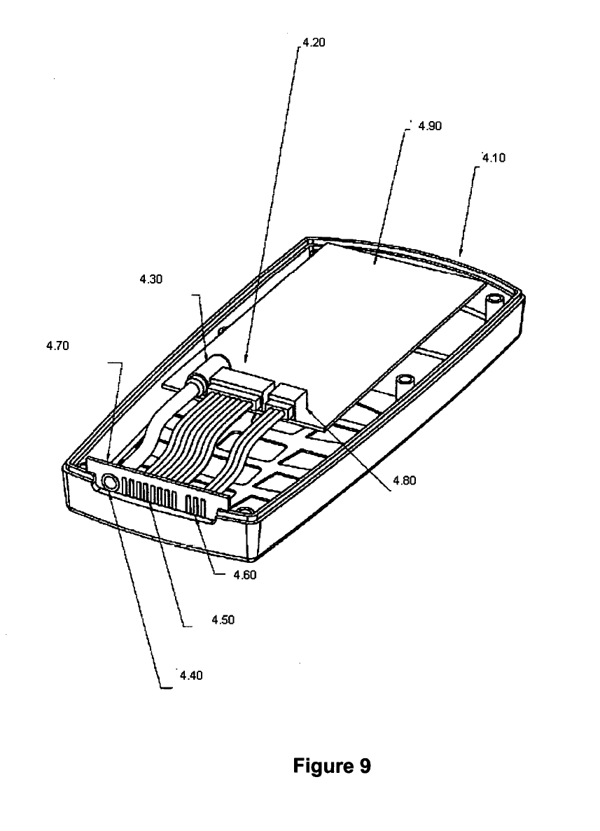

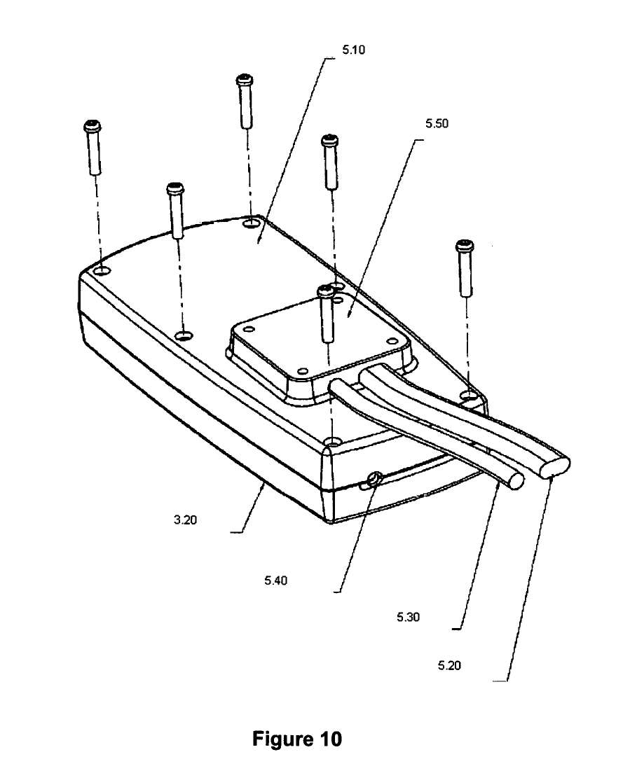

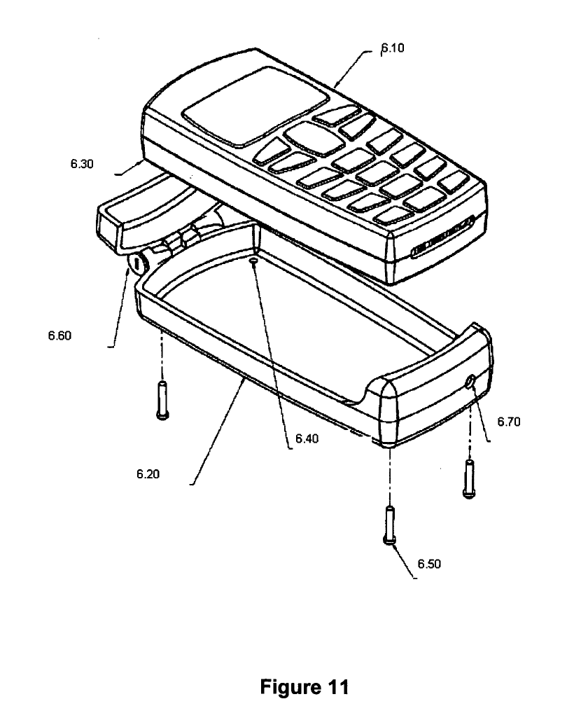

FIGS. 8-11 show examples of the mobile phone's components, and a process for interchanging the phone between a portable and mounted device. As shown, FIG. 8 includes screws 3.40, standard back cover portable phone 3.10, front cover 3.20, and removable power and data contacts 3.30. FIG. 9 shows pcb mounted data, microphone, speaker and power connections 4.20 which connect to the external data contacts via a ribbon cable, main telephone pcb 4.90, front cover 4.10, pcb mounted antenna connector and cable to data connector assembly 4.80, external antenna connectors 4.60, external data and power connectors 4.50, external 2.5 mm ear phone jack connector 4.40, external data connector assembly 4.70 and pcb mounted earphone connector and cable to data connector assembly 4.30. FIG. 10 shows fixed back cover (second rear cover) 5.10, fixed telephone mounting plate 5.50, same front cover as 3.20, 2.5 mm external ear phone jack connector 5.40, external antenna cable 5.30, and data, microphone, speaker and power cable assembly 5.20. FIG. 11 shows mobile telephone 6.10, rear cover 6.30, key lock 6.60, hands free telephone cradle 6.20, through mounting holds 6.40, long mounting screw 6.50, and external ear phone jack connector 6.70.

Conversion of Portable to fixed mobile phone is done via the following process. This process could be undertaken by the phone retailer, phone installer, the customer/owner of the phone or the unit could be sent back to the manufacturer/distributor to be converted:

### Part A) Removal of the Standard Rear Cover:

1. Remove screws no's 1,2,3,4,5 and 6 (3.40)

2. Remove the standard rear plastic phone cover (3.10). Removable of the standard rear plastic phone cover (3.10) exposes the internal components of the phone.

3.Disconnect the 2.5 mm earphone jack connector fly lead from the main phone PCB (4.30)

4. Disconnect the data connector and ribbon at the main phone PCB end (4.20)

5. Disconnect the External antenna cable at the connector mounted on the main phone PCB (4.80)

6. Remove the Data Connector Assembly (4.70)

### Part B) Installation of the Fixed Rear Cover:

1. Connect 2.5 mm earphone jack fly lead to Main Phone PCB (4.30)

2. Connect Data, Microphone, speaker and power cable assembly (5.20) to corresponding data connector on the Main Phone PCB (4.20) cables to be put through the Fixed Back Mounting plate (5.50) prior to being connected to the main phone PCB.

3. Connect Antenna cable (5.30) to the main phone PCB antenna connector (4.80) Antenna cable to be put through the Fixed Back Mounting plate (5.50) prior to being connected to the main phone PCB.

4. All cables exit and are supported by the Fixed Back Mounting Plate (5.50) which forms part of the Fixed Back Cover (5.10)

5. Place the Fixed Back Cover (second rear cover) (5.10) over the front cover (3.20) and screw down using the same six screws as removed in (3.40). Placing the second rear cover (5.10) over the phone covers the internal components of the phone.

### Portable to Fixed-In-Vehicle Phone Conversion:

Another method of converting a portable mobile phone to fixed mobile and visa versa involves a portable mobile phone that is clipped into its hands free kit. This mobile phone hands free car kit is specially designed so it can then allow the owner to mount the phone permanently into the hands free car kit itself. This is achieved without having to change the mobile phone back or any other components within the phone.

This concept differs from the interchangeable fixed back in that it is a bulkier installation as you have the phone and car kit mounted in the vehicle.

Conversion of a hands-free Car Kit and portable mobile phone to a Fixed In-Vehicle phone is achieved in the following way.

The mobile phone hands free car kit cradle (6.20) is designed in such a way that there are two or more holes (6.40) in the car kit cradle (6.20) that are positioned in the exact same location as the mounting screws that hold the front and rear phone covers together (6.30).

The following process achieves conversion of Portable Mobile to be fixed in to a hands free car kit. This process can easily be undertaken by the customer/owner of the phone:
1. Remove mounting screws 2 & 5 from the Mobile Phone (6.10)
2. Place mobile phone in to the hands free kit cradle as per normal.
3. Take the long screws 7 & 8 (6.50) and put them through the non-threaded holes (6.40 and 6.45) in the hands free car kit cradle and into the mobile phone.
4. Tighten screws to lock down the phone into the hands free car kit.

### Portable to Fixed-In-Vehicle Phone Conversion:

One embodiment of the invention is directed to a mobile phone car kit with key operated lock to permanently mount the mobile phone in to the car kit.

This option involves the ability to lock a portable mobile phone into a hands free car kit cradle. This is done via a key locking mechanism fitted into the hand free car kit cradle. The key lock prevents the spring loaded clip mechanism from allowing the mobile phone to be released from the car kit.

The following process achieves conversion of Portable Mobile Phone to be fixed in to a hands free car kit. This process can easily be undertaken by the customer/owner of the phone:
1. Place the mobile phone (6.10) in to the hands free car kit cradle (6.20) as per normal.
2. Use the key provided with the hands free car kit to lock the phone in place.

### Floating Portable Unit:

In an embodiment of the present invention, the unit is adapted so as to be able to float. In some embodiments, floating is achieved by means of a floatation component. The floatation component may form any suitable part of the unit, and in some embodiments it comprises a compartment which may be at any suitable location, for example, the cover. In some embodiments, the floatation component comprises trapped air, or a material of lower density than water, such as, for example, polystyrene foam.

In some embodiments, the rear cover comprises the floatation component. In other embodiments, there is provided a rear cover which is engagable with one or more currently sold units (such as mobile phones) so as to enable retro-fitting of the floating functionality. In some preferred embodiments, the unit is waterproof, however, this is not essential to this embodiment.

Provision of floatation capability has great utility in environments in which there is a reasonable risk that a dropped unit will sink within a liquid such as water. Thus, fishermen and other marine workers will find great utility in a unit according to this embodiment of the invention.

Incorporation of Software and/or Hardware in a Unit that Renders the Unit Inoperable when a Vehicle is in Motion at, Above, Below or Within a Range of a User Defined Vehicle Speed Conditions:

In an embodiment of the present invention, software and/or hardware incorporated into a fixed or portable unit such as a radio cellular telephone may be set to render the unit inoperable under certain conditions. Thus, for example, the unit may be set not make or receive calls at, above or below user-defined vehicle speeds. Similarly, the unit may be forced to shut down completely or remain logged on to a cellular network but not allow the user to use some or all of the phones functions. The speed of the unit may be determined by any suitable mechanism, for example, GPS, interfacing of the phone to a vehicles odometer, or by the use of an accelerometer within the phone or a combination of one or more of these methods.

In one embodiment, a transportation fleet operator may decide for occupational health and safety reasons that the way for the phone to operate is whilst the vehicle is stationary as is the case in the petro-chemical transport industry in some states of Australia and other countries. Fleet operators may install “isolation switches” to shut down power to the phone to force it to turn off when in motion. The embodiment of the invention makes this a simple matter of switching on this function in the phone.

In one embodiment, a transport fleet operator may want the phone to operate above a certain speed, for example >50 kmh. This would render the phone inoperable, although still powered on, and logged on to the cellular network for receipt of SMS text and/or voice mail notification. Under these criteria, for example, the phone would not operate in School Zones, Busy peak hour traffic etc,—conditions where maximum driver concentration should be engaged.

In one embodiment, the software may be used to force the phone to be inoperable for standard phone calls, data and SMS at speeds above 130 kmh thus preventing the phone from being used in an Aircraft.

Incorporation of Software in a Unit that Allows the User to Disable Use of Either Inbound or Outbound Short Message Service “SMS”:

According to another embodiment of the invention, the user of a unit and/or its owner in a fleet environment may have multiple options to disable or restrict the use of SMS. software according to this embodiment of the invention may be designed to provide the following options:
Completely disable SMS inbound and/or outbound.
Disable all inbound and/or outbound SMS, with the exception of voicemail notification from the Cellular Network Operator.
Restrict Inbound or Outbound SMS or both to phone numbers stored on the phone's memory. These numbers stored may be either on the SIM card and/or in the user Phone Book, they may or may not also be from a restricted or fixed dialling list within the phone book list contained in the cellular phone.
Restrict outbound SMS to that of a predetermined or customised list of SMS Templates.

In some embodiments, SMS disable features may also be dependent or used with the user defined vehicle speed conditions. In some embodiments, a combination of one or more of the above features may be used.

Incorporation of Software in a Unit Fitted with Multiple Sim Card Capability, that Allows Stored Phone Book Entries in the Unit's Memory to be Assigned or Tagged to an Individual SIM Card:

In another embodiment of the invention, a unit is fitted with multiple SIM capability, and comprises the ability to have different call types or phone numbers tagged to a particular sim card without having to manually select which SIM the user wishes to use.

Any of the Sim Cards may be user defined as the default or main SIM and the alternate SIMs may be defined as the secondary or personal SIMs. Unless changed by the user, SIM one remains the default SIM. During general operation, the unit or phone's software may return to the prime SIM after use of a secondary SIM. The software may provide for prolonged use on a secondary DIM but at certain intervals will switch back to the prime SIM for a short period of time to ensure any SMS Text messages and/or voicemail notifications are received via the default or prime SIM.

A company or organization that uses many phones may, as a policy prevent personal calls from a mobile and/or SIM Card provided to the user. In this example the user would store company related phone numbers to the Phone's memory and these would be tagged to the Work SIM. Personal contacts would be stored to the Phone's memory but tagged to the Personal SIM.

The default status of the phone is to have the default SIM logged on to the Cellular Network.

Should the user elect to make a personal call he would select the stored personal number from the phone's memory and press, “send”. The phone's software would recognise this as a previously stored personal number and proceed to log the Default SIM from the network and log the personal SIM on to the network. Once the personal call has been completed the phone will remain logged onto the personal SIM for a set, user defined, amount of time as agreed with the provider of the phone and/or SIM. The default period of time the phone remains on the personal SIM may, for example, be two minutes.

SIM one and SIM two etc may or may not belong to or register on the same cellular network.

This embodiment of the invention can have significant cost saving benefits should one network have competitive daytime billing plans and another have a competitive night time call billing plans. This equally applies to using two different SIMs to take advantage of comparative local call rates from one Network Provider and competitive long distance rates from the alternate Network Provider.

Note that use of two SIMs in older versions of phones requires the user to go into the phones menu and user conditions to change which SIM is to be active on the phone each time and then repeat the whole process to switch it back again (if they don't forget). Whilst phone numbers can be stored on either SIM on these older phones, numbers stored on SIM 1 are not accessible when SIM 2 is in use and visa versa. Numbers stored on the Phone's Memory would be accessible to both SIMs and this in fleet vehicle operations may not be desirable.

Historically Multiple SIM capable Mobile phones have not been able to let phone numbers stored on the phones memory to be tagged or assigned to an individual SIM, without being stored on the SIM itself. Software according to this embodiment of the invention gives the user of a multiple SIM mobile phone the choice to either tag phone numbers on the phone's main memory for use by an individual SIM, or if selected allow its use by Multiple SIMs.

Incorporation of Voice Recognition Software within a Fixed or Portable Unit that Allows Some or All of the Unit's Features to be Used by One or More Authorised Users where the Unit has the User/s Voice “Signature or Imprint” Registered on the Unit:

In embodiment of the invention, a unit is provided with voice recognition software that allows some or all of the unit's features to be used by one or more authorised users depending on the user's voice signature or imprint. Such an embodiment is particularly useful to render the unit inoperable if stolen, or to restrict inappropriate use by a non-authorised person.

Should a cellular phone or group of phones be used by a team of senior executives dealing with highly sensitive commercial information, such phones could potentially run the risk of being used and/or interrogated for the information stored on the phone by other people. With the voice signature software incorporated in the phone's software it would then render the phone inoperable to anyone other than the person or people authorised to use it. Similarly certain functions on a phone may require a particular voice signature before activation.

Inductive Charge of the Battery within a Unit:

According to another embodiment of the invention, a unit is provided which comprises a battery which is able to be charged inductively. This embodiment allows the design and construction of the outer casing of the phone to have no external metal connectors for charging of the battery. Such a design is particularly important for the design of units such as mobile phones to be used in Hazardous environments such as Gas and Petrochemical production plants etc.

Currently to meet Occupational Health and Safety guidelines in many countries an “Intrinsically safe” mobile phone may be used in certain hazardous environments if the phone has it's battery connector's covered by a simple rubber or leather carry case or alternatively a rubber type plug. A problem with this is that it relies on the user of the phone to not forget to put the plug in or the carry case on the phone. Such prior art carry cases may be removed each time the phone needs to be charged. A mobile phone with inductive charging removes the requirement of the case and further eliminates the potential danger of a phone accidentally being taken into a hazardous environment with its Battery Connectors Exposed.

The construction of units with inductive charge capability also further aids in sealing the unit—making it impervious to water and some types of gas penetration.

Flash Tones—Incorporation of Software and Hardware in a Fixed or Portable Unit to Allow User Defined Flash Sequences of the Back Lighting of a Unit to be Created and Assigned to Various Functions within the Unit:

In another embodiment of the present invention, multiple variations of flash sequences of the unit's back lighting may be created by the user and then linked to certain functions, or event occurrences.

Individual flashing sequences may, for example, be assigned to certain names stored in the phones memory or on the SIM card. A certain flash sequence may be used just to identify an incoming SMS Text message from a known party. The custom flash sequence may be selected for Voice mail notification etc. This feature is of particular benefit when a mobile may be in use in a noisy environment such as a truck cabin. Notification of important inbound calls, messages or alerts etc may be vital yet often missed, as normal ring tones are not heard.

Under certain circumstances the user may also, for example, choose to ignore all normal calls and react to those with the user defined flash sequence.

In some embodiments, the user may also choose from a number of pre defined flash sequences contained within a unit. Should the unit also be designed with multiple colour LED's or other form of colour backlighting these variations in colour may also be added into the user defined flash sequences.

In other embodiments, the unit's screen may display a variety of pictures which correspond to the various functions or event occurrences. For example, a picture of the person who is calling or who has just sent an SMS may be displayed on the screen in response to arrival of the call or SMS. Similarly, fireworks or some other picture may display if a voicemail is left, etc.

### PEDA—Personal Emergency Duress Alarm—Device:

In another embodiment the invention, there is provided a low power radio transceiver accessory for use with a handheld or Fixed In-Vehicle unit such as a phone for hands-free use of the mobile phone. The device comprises an additional dedicated button for use in a Duress or Emergency alarm application. An alert may be triggered via such a button in a number of ways. These include but are not limited to, one single long press of 5 seconds, three quick taps or depressions of the emergency button, one short and two long etc. The sequence or method may be designed in such away to significantly minimise any false alarms.

Designs of other specific low power wireless accessory devices to operate with the mobile phone may also include, Belt clip devices, key chain fob devices and necklace based devices. These specific devices may be paired with the mobile phone (for example, via Bluetooth) to be able to initiate a duress alert as described above.

### PEDA—Personal Emergency Duress Alarm—Software:

In another embodiment of the invention, software is incorporated that allows the use of one or more existing buttons on a commonly available wireless accessory to a mobile phone, to be used to trigger an emergency duress alert phone call, SMS message or both. The alert or alerts may be sent via one or more communication methods available to the phone but most commonly via SMS, standard cellular phone call, packet data or a combination of one or more of these methods.

Wireless accessories for use with this and the other embodiments of the invention may for example be low power radio transceivers used for hands-free operation such Infrared, Wibee, and Bluetooth etc. Thus, for example this embodiment of the invention is particularly useful with the most common forms of device such as wireless earpieces, wireless headsets and the like made for use with a mobile phone.

This software application may be incorporated in the operating system firmware of the mobile phone device, or it may be a program installed on the phone via a third party software platform or application such as Windows Mobile, Windows CE, JAVA, BREW and any other type of software platform that can be loaded on to the mobile.

In some embodiments, the application may be loaded via a software platform already accepted by a current mobile phone and thus allow the application to be applied to any cellular phone in the current market place that readily accepts third party software applications. In other embodiments, an updated revision of a current phone's operating software incorporating the Personal Emergency Duress Alarm concept may be loaded on to the mobile.

1. A method for managing a mobile device, comprising:
receiving information for determining a spatial state of the mobile device;
receiving a communication event for the mobile device;
if the communication event is at least one of a plurality of preselected types and the spatial state of the device satisfies a preselected condition, call-processing the communication event while initiating a notification of the event to a user of the mobile device; and,
otherwise, disabling at least the call-processing of the communication event and/or the notification of the event to the user.

2. The method of claim 1, wherein if the communication event is not one of the preselected types or the spatial state does not satisfy the preselected condition, the communication event is call-processed and the notification of the event to the user is disabled.

3. The method of claim 1, wherein: the call-processing comprises one or more of:
enabling audio and/or visual communication by the user,
storing a Short Message Service (SMS) message,
activating an alarm,
forwarding the communication event to another device, or
recording a missed call within a memory;
and the spatial state comprises:
a speed and/or velocity of the mobile device,
an acceleration of the mobile device,
a position of the mobile device,
an altitude of the mobile device,
a vibration of the mobile device, or
a combination thereof.

4. A system for managing a mobile device, comprising:
a transceiver for communicating data over a network;
a spatial sensor; and,
a processor configured to perform actions comprising:
receiving a communication event from the transceiver;
determining a spatial state of the device based on information from the spatial sensor,
determining if the event is at least one of a preselected plurality of types and a spatial state of the device satisfies at least one preselected condition, and,
based on a result of the determining step, call-processing the communication event while disabling an indication of the event to a user of the mobile device.

5. The system of claim 4, wherein the spatial sensor comprises: an altimeter, a barometer, an accelerometer, a pressure sensor, a thermometer, a Global Positioning System (GPS) component, a Radio Triangulator, an inertial sensor, a speedometer, an odometer, or a vibration sensor.

6. A processor readable medium for managing a mobile device comprising instructions that when executed by a processor causes the processor to perform actions comprising:
receiving a communication event for the mobile device;
if the event satisfies and a determined spatial state of the device satisfy one or more preselected conditions for disabling at least a portion of the device, performing a call-processing configured for the device while disabling another call-processing configured for the device; and,
otherwise, performing the call-processing while performing the other call-processing.

7. The processor readable medium of claim 6, wherein the communication event is a call, and wherein the call-processing comprises receiving an inbound call, call-forwarding the inbound call, or enabling making an emergency phone call, and wherein the other call-processing comprises making an outbound call, alerting of a missed call, or providing a Short Message Service (SMS).

8. A method for managing a mobile device, comprising:
configuring a mobile device to save data based on at least one change of a spatial state of the mobile device associated with a use of the device outside working parameters for the device; and,
optionally providing an indication that the device is out of warranty based on the data.

9. A system for managing a mobile device, comprising:
a mobile device configured to save data in relation to at least one change of a spatial state of the mobile device associated with a use of the device outside working parameters for the device; and,
a warranty component configured to receive the data; and optionally provide an indication that the device is out of warranty based on the statistic.

10. A processor readable medium for managing a mobile device comprising instructions that when executed by a processor causes the processor to perform actions comprising:
configuring a mobile device to save a statistic of at least one change of a spatial state of the mobile device associated with a use of the device outside working parameters for the device; and,
optionally providing an indication that the device is out of warranty based on the statistic.

11. An system for interchanging a mobile device, comprising:
a rear cover interchangeably attached to a rear side of the mobile device;
a power connection in communication with the mobile device;
a communication connection in communication with the mobile device; and,
a fixed back plate attached to a mounting configured to attach to the rear side of the mobile device to interchange the rear cover after removal of the rear cover from the rear side of the mobile device, wherein the fixed back plate includes another connection configured to be coupled to the power and communication connections.

12. A communications device comprising software that allows the use of one or more existing buttons on a commonly available wireless accessory to a mobile phone, to be used to trigger an emergency duress alert phone call, SMS message or both.

13. A communications device comprising one or more of:
a motion sensor to measure changes in forces applied to the device and/or to assist with tracking and location of the device;
a sensor to receive data relevant to the relative height of the device as compared to another device or point in space and a data storage means to store the data;
an electromagnetic shield to restrict transmission of electromagnetic radiation towards a body part of the user;
a back-up source to provide power in the event of loss of power from the vehicle;
an internal antenna;
software and/or hardware to monitor the vehicle's electrical systems, such as the vehicle battery condition;
text-to-speech functionality;
an interchangeable portion so as to enable the same basic unit to become a fixed-in-vehicle or a handheld unit;
a floatation component;
multiple SIM card capability, and wherein different call types or phone numbers may be tagged to a particular SIM card without the need to manually select which SIM the user wishes to use;
voice recognition software that allows some or all of the unit's features to be used by one or more authorised users depending on the user's voice signature or imprint;
a battery which is able to be charged inductively;
a visual display function, such as a flash sequence function responsive to a device function or event;
enabled to interoperate with an accessory wherein the accessory enables a duress or emergency signal to be sent from the device;
software that allows the use of one or more existing buttons on a commonly available wireless accessory to a mobile phone, to be used to trigger an emergency duress alert phone call, SMS message or both;
a receiver, a transmitter and a processor and further comprising a safety feature to increase the safety of the user wherein the safety feature is enabled by one or more of a motion sensor, altimeter, accelerometer, gyroscope, and GPS;
a transceiver for communicating data over a network;
a spatial sensor which comprises an altimeter, a barometer, an accelerometer, a pressure sensor, a thermometer, a Global Positioning System (GPS) component, a Radio Triangulator, an inertial sensor, a speedometer, an odometer, or a vibration sensor;
a processor configured to perform actions comprising:
receiving a communication event from the transceiver;
determining a spatial state of the device based on information from the spatial sensor,
determining if the event is at least one of a preselected plurality of types and a spatial state of the device satisfies at least one preselected condition, and,
based on a result of the determining step, call-processing the communication event while disabling an indication of the event to a user of the mobile device;
configuration to save data in relation to at least one change of a spatial state of the mobile device associated with a use of the device outside working parameters for the device;
a warranty component configured to receive the data; and provide an indication that the device is out of warranty based on the data.
a rear cover interchangeably attached to a rear side of the mobile device;
a power and communication connection in communication with the mobile device; and,
a fixed back plate attached to a mounting configured to attach to the rear side of the mobile device to interchange the rear cover after removal of the rear cover from the rear side of the mobile device, wherein the fixed back plate includes another connection configured to be coupled to the power and communication connection.

14. A communications device according to claim 13 comprising all of the features listed therein.

15. A communication device comprising a receiver, a transmitter and a processor and further comprising a safety feature to increase the safety of the user wherein the safety feature is enabled by one or more of a motion sensor, altimeter, accelerometer, gyroscope, and GPS.

16. A method for managing a mobile device, comprising:
receiving information for determining a spatial state of the mobile device;
disabling the mobile device if the spatial state satisfies a preselected condition, and,
optionally re-activating the mobile device once a second preselected spatial state condition is met.

17. A system for managing a mobile device, comprising:
a transceiver for communicating data over a network;
a spatial sensor; and,
a processor configured to perform actions comprising:
determining a spatial state of the device based on information from the spatial sensor,
determining if the spatial state of the satisfies at least one preselected condition, and,
based on a result of the determining step, disabling the mobile device and/or disabling an indication of the event to a user of the mobile device.
